(19) United States
(12) Patent Application Publication
(10) Pub. No.: US 2025/0140904 A1
(43) Pub. Date: May 1, 2025

(54) LOW-COST MULTI-CATIONIC LI-BORACITE AS A SOLID STATE IONIC CONDUCTOR FOR LITHIUM BATTERIES

(71) Applicant: SAMSUNG ELECTRONICS CO., LTD., Suwon-si (KR)

(72) Inventors: Mahdi Amachraa, Cambridge, MA (US); Yan Wang, Brookline, MA (US); Heung Chan Lee, Suwon-si (KR); Giyun Kwon, Suwon-si (KR)

(73) Assignee: SAMSUNG ELECTRONICS CO., LTD., Suwon-si (KR)

(21) Appl. No.: 18/424,425

(22) Filed: Jan. 26, 2024

Related U.S. Application Data
(60) Provisional application No. 63/546,660, filed on Oct. 31, 2023.

(51) Int. Cl. H01M 10/0562; H01M 10/0525

(52) U.S. Cl. CPC H01M 10/0562; H01M 10/0525; H01M 2300/008

(57) ABSTRACT

A compound has the formula Li₄₋ₓB_{7-y}M_{y}O_{12-z}Cl_{w}, wherein Li, O, and Cl vacancies are allowed and M is either a one-way, two-way or three-way combination of the following species: Al³⁺, Fe³⁺, B³⁺, La³⁺, Y³⁺, Mo³⁺, Be²⁺, Si⁴⁺, Cr⁴⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺, and wherein 0≤x<2, 0<y<6, 0≤z<1, and 0<w<2 either satisfy a charge balance mechanism with their respective defect site B³⁺, Li⁺, O²⁻, or Cl⁻, or satisfy any combination that maintains charge neutrality of the compound, and wherein when M comprises Al³⁺, M is a two-way or three-way combination. A glass ceramic composition includes the compound. A lithium ion battery includes a solid state ionic conductor, wherein the solid state ionic conductor includes the compound.

### CROSS-REFERENCE TO RELATED APPLICATION

This application is based on and claims priority from U.S. Provisional Application No. 63/546,660 filed on Oct. 31, 2023 in the U.S. Patent and Trademark Office, the disclosure of which is incorporated herein by reference in its entirety.

### BACKGROUND

### 1. Field

Materials according to embodiments relate to solid electrolyte materials for Li solid-state batteries.

### 2. Description of the Related Art

In order to reduce the production of carbon dioxide in our society, the demand for rechargeable batteries has drastically increased. A lithium-ion battery has been utilized in these applications due to its highest energy density amongst rechargeable batteries. However, achieving a higher energy density, high ionic conductivity materials with appropriate environmental stability, chemical stability and electrochemical stability has been an ongoing challenge.

Lithium boracite crystals with a general formula of Li₄₊ₓB₇O₁₂₊ₓX_{y} have been identified as promising Li-ion conductors in an all-solid-state battery, where X is a monovalent or divalent anion. When x=0 and X=Cl (Li₄B₇O₁₂Cl cubic space group), the conductivity is the highest at room temperature. Partial replacement of the X anion with other X′ is also possible and normally leads to the stabilization of another phase at room temperature and abruptly drops the conductivity near room temperature.

Currently, doping the boron site with Al (Li₄B₄Al₃O₁₂Cl) has been shown to lead to the formation of a glass-ceramic that is stable against Li metal and with a wide electrochemical window between 0 and 6 V vs. Li/Li⁺ and a Li⁺ ion transport number of roughly 1.

However, despite the boracite's structural variety, the replacement of the B—O framework with other cationic framework has only been investigated for Al/Ga dopants. Indeed, such replacement of the B—O framework is highly difficult or often impossible, primarily because of the very small ionic radius of the B³⁺ sites compared to other cations.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on the development of new Li-boracite compositions where the introduction of multi-dopant species into the B³⁺ site leads to thermodynamically stable Li-boracite phases, previously unknown.

The present disclosure is directed to non-obvious doping strategies of the parent cubic structure Li₄B₇O₁₂Cl, wherein the tetrahedral BO₄ units in the parent lithium chloroboracite, Li₄B₇O₁₂Cl, are either partially or fully replaced. These non-obvious substituted compounds are formed as the stable primary phase in high crystalline glass-ceramics composed of a Li₂O—B₂O₃-MₓO_{y}—LiCl high-dimensional system where M can either be a trivalent specie, or a mixture of bivalent, trivalent, tetravalent or pentavalent species. Accordingly, the compounds of the present disclosure can generally adopt the following chemical form of Li₄₋ₓB_{7-y}M_{y}O_{12-z}Cl_{w} where Li, O, and Cl vacancies are allowed and M can be either a one-way, two-way or three-way combination of the following species: Al³⁺, Fe³⁺, B³⁺, La³⁺, Y³⁺, Mo³⁺, Be²⁺, Si⁴⁺, Cr³⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺. Here, 0<x<2, 0<y<6, 0<z<1, 0<w<2 can either satisfy a charge balance mechanism with their respective defect site (B³⁺, Li⁺, O²⁻, or Cl⁻), or satisfy any combination that maintains the charge neutrality of the overall composition. The concurrent multi-specie doping of the B³⁺ site and vacancy generation of either Li, O or Cl increases the configurational entropy (i.e. ˜ 100 meV/atom) which subsequently increases the thermodynamic stabilization of non-obvious species on the B³⁺ site.

The present disclosure demonstrates several approaches to optimize the Li-boracite compositions through the doping of the B³⁺ sites as to maximize the content of previously unknown elements and cheaper elements.

The present disclosure provides a compound of the formula Li₄₋ₓB_{7-y}M_{y}O_{12-z}Cl_{w}
where M can either be a trivalent specie, or a mixture of bivalent, trivalent, tetravalent or pentavalent species,
where M can be either a one-way, two-way or three-way combination of the following species: Al³⁺, Fe³⁺, B³⁺, La³⁺, Y³⁺, Mo³⁺, Be²⁺, Si⁴⁺, Cr⁴⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺,
where 0<x<2, 0<y<6, 0<z<1, 0<w<2 can either satisfy a charge balance mechanism with their respective defect site (B³⁺, Li⁺, O²⁻, or Cl⁻), or satisfy any combination that maintains the charge neutrality of the overall composition, and
wherein the formula is Li₈Y₄B₉Mo(ClO₁₂)₂, Li₈Y₄CrB₉(ClO₁₂)₂, or Li₈Y₃B₈Mo₃(ClO₁₂)₂.

An embodiment of the present disclosure includes a compound of the formula Li₄₋ₓB_{7-y}M_{y}O_{12-z}Cl_{w}, wherein Li, O, and Cl vacancies are allowed and M is either a one-way, two-way or three-way combination of the following species: Al³⁺, Fe³⁺, B³⁺, La³⁺, Y³⁺, Mo³⁺, Be²⁺, Si⁴⁺, Cr⁴⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺, and wherein 0≤x<2, 0<y<6, 0≤z<1, and 0<w<2 either satisfy a charge balance mechanism with their respective defect site B³⁺, Li⁺, O²⁻, or Cl⁻, or satisfy any combination that maintains charge neutrality of the compound, and wherein when M comprises Al³⁺, M is a two-way or three-way combination.

Another embodiment includes the aforementioned compound wherein 0<x<2, 0<y<6, 0<z<1, and 0<w<2.

Another embodiment includes the aforementioned compound wherein the compound is Li₈Y₄B₉Mo(ClO₁₂)₂.

Another embodiment includes the aforementioned compound wherein the compound is Li₈Y₄CrB₉(ClO₁₂)₂.

Another embodiment includes the aforementioned compound wherein the compound is Li₈Y₃B₈Mo₃(ClO₁₂)₂.

Another embodiment includes the aforementioned compound wherein M is one, two, or three of Fe³⁺, La³⁺, Y³⁺, Mo³⁺, Cr⁴⁺, As³⁺, Fe²⁺, Mo⁴⁺, Mo⁶⁺, As³⁻, or As⁰⁺ or two or three of Al³⁺, Fe³⁺, La³⁺, Y³⁺, Mo³⁺, Cr⁴⁺, As³⁺, Fe²⁺, Mo⁴⁺, Mo⁶⁺, As³⁻, or As⁰⁺.

Another embodiment includes the aforementioned compound wherein M is a two-way combination.

Another embodiment includes a glass ceramic composition comprising the aforementioned compound.

Another embodiment includes a lithium ion battery comprising a solid state ionic conductor, wherein the solid state ionic conductor comprises the aforementioned compound.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawings in which:

FIGS. 1A and 1B are graphs of an exemplary embodiment to show the upper limit of the number of dopants.

FIG. 2 is a graph showing the ideal configurational entropy energy (S_{ideal}) vs. temperature in Kelvin when 3 dopants are inserted on the B³⁺ site.

FIG. 3 is a graph showing an exemplary embodiment with (A) Eₕᵤₗₗ<100 meV/atom and (B) optimized price differential.

FIG. 4 is a graph showing an exemplary embodiment with (A) Eₕᵤₗₗ<100 meV/atom and (B) high Li conductivity.

FIG. 5 is a graph showing an exemplary embodiment with (A) Eₕᵤₗₗ<100 meV/atom, (B) high Li conductivity, and (C) high moisture stability.

FIG. 6 is a graph showing defects dopant strategies in an exemplary embodiment.

### DETAILED DESCRIPTION OF EXAMPLE EMBODIMENTS

The embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure. For example, even if matters described in a specific example or embodiment are not described in a different example or embodiment thereto, the matters may be understood as being related to or combined with the different example or embodiment, unless otherwise mentioned in descriptions thereof. In addition, it should be understood that all descriptions of principles, aspects, examples, and embodiments of the disclosure are intended to encompass structural and functional equivalents thereof. In addition, these equivalents should be understood as including not only currently well-known equivalents but also equivalents to be developed in the future.

As used herein, expressions such as “at least one of,” when preceding a list of elements, modify the entire list of elements and do not modify the individual elements of the list. For example, the expression, “at least one of a, b and c,” should be understood as including only a, only b, only c, both a and b, both a and c, both b and c, or all of a, b and c.

The present disclosure provides non-obvious doping strategies of the parent cubic structure Li₄B₇O₁₂Cl, wherein the tetrahedral BO₄ units in the parent lithium chloroboracite, Li₄B₇O₁₂Cl, are either partially or fully replaced. These non-obvious substituted compounds are formed as the stable primary phase in high crystalline glass-ceramics composed of Li₂O—B₂O₃-MₓO_{y}—Li—Cl high-dimensional system where M can either be a trivalent specie, or a mixture of bivalent, trivalent, tetravalent or pentavalent species. Accordingly, the compounds of the present disclosure can generally adopt the following chemical form of Li₄₋ₓB_{7-y}M_{y}O_{12-z}Cl_{w} where Li, O, and Cl vacancies are allowed and M can be either a one-way, two-way or three-way combination of the following species: Al³⁺, Fe³⁺, B³⁺, La³⁺, Y³⁺, Mo³⁺, Be²⁺, Si⁴⁺, Cr⁴⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺. Here, 0<x<2, 0<y<6, 0<z<1, 0<w<2 can either satisfy a charge balance mechanism with their respective defect site (B³⁺, Li⁺, O²⁻, or Cl⁻), or satisfy any combination that maintains the charge neutrality of the overall composition. The concurrent multi-specie doping of the B³⁺ site and vacancy generation of either Li, O or Cl increases the configurational entropy (i.e. ˜ 110 meV/atom) which subsequently increases the thermodynamic stabilization of non-obvious species on the B³⁺ site.

Benefits of the concurrent multi-specie doping of the B³⁺ site and vacancy generation of either Li⁺, O²⁻, or Cl⁻ are:
Increases the total configurational entropy, reduces the coexistence of the BO₄ and MO₄ polyhedron units and inhibits the introduction of a large strain in the cationic framework which subsequently increases the stability of non-obvious dopants on the B³⁺ site.
Multiple chemical design strategies to minimize the total cost of the cubic Li₄₋ₓB_{7-y}M_{y}O_{12-z}Cl_{w} while preserving or enhancing the Li-ionic conductivity of the parent cubic structure.
Maximize the resistance to electrochemical decomposition through the insertion of a diverse set of species of different oxidation states and sizes which lead to a substantial increase of configurational entropy.
Reducing the reduction potential against Li metal, therefore increasing Li stability in solid-state batteries.
Increases the aqueous stability of the boracite structure against moisture.

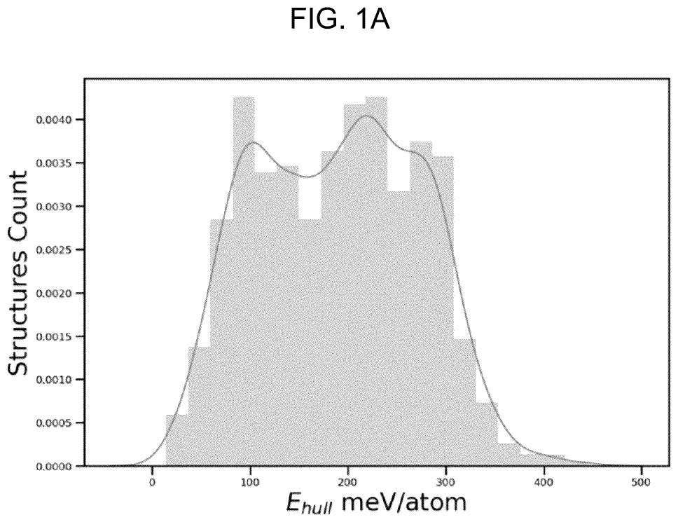

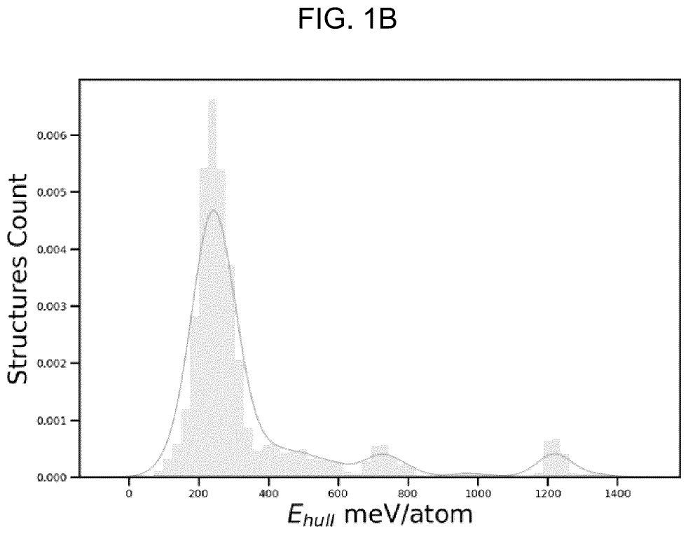

FIGS. 1A and 1B relate to an exemplary embodiment showing the upper limit of the number of dopants. The results in FIGS. 1A and 1B show, first of all, the non-obvious character of designing dopants to sit on the B³⁺ site. These results show that in the Li₄₋ₓB_{7-y}M_{y}O_{12-z}Cl_{w} structure, the upper limit of the number of dopants that the B³⁺ site can accommodate is 3. Therefore, embodiments of the present disclosure can have up to 3 species on the B³⁺ site.

The chemical compositions in the present disclosure are therefore those that minimize the MO₄, and BO₄ polyhedron strain by increasing the total configurational entropy and maintaining the cubic framework of the parent structure, minimize the total cost of the material, and either maintain or increase the Li-ionic conductivity of the cubic parent structure:

Li₄₋ₓB_{7-y}M_{y}O_{12-z}Cl_{w}
where Li, O, and Cl vacancies are allowed and M can be either a one-way, two-way or three-way combination of the following species: Al³⁺, Fe³⁺, B³⁺, La³⁺, Y³⁺, Mo³⁺, Be²⁺, Si⁴⁺, Cr⁴⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺. Here, 0<x<2, 0<y<6, 0<z<1, 0<w<2 can either satisfy a charge balance mechanism with their respective defect site (B³⁺, Li⁺, O²⁻, or Cl⁻), or satisfy any combination that maintains the charge neutrality of the overall composition. In another embodiment, 0≤x<2, 0<y<6, 0≤z<1, and 0<w<2.

Embodiments of the present disclosure can be made using a standard solid-state method. In this method, precursor powders are combined in a certain ratio depending on the composition of the target material. As one example, precursors may consist of lithium carbonate (Li₂CO₃), boric oxide (B₂O₃), lithium chloride (LiCl), and at least one precursor containing an included metal from M, and as another example, precursors may consist of lithium oxide (Li₂O), boric oxide, lithium chloride, and at least one precursor containing an included metal from M. Examples of metal precursors include metal oxides, hydroxides, carbonates, and nitrates.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature for an appropriate period of time to produce a powder with the desired composition and crystal structure. A ceramic composition such as a glass ceramic composition can be prepared including the powder.

Subsequently the powder may be compressed using a hydraulic uniaxial press to form a densely packed pellet. Heat treatment may then be applied at an appropriate temperature for an appropriate period of time to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

### Examples

Embodiments will now be illustrated by way of the following examples, which do not limit the embodiments in any way.

With the use of high-throughput density functional theory (DFT) calculations, a wide range of non-obvious potential chemical dopants was selected based on their electronegativity, Shannon's crystal radius, and oxidation state. The initial set of potential chemical dopants includes 45 species selected as: Y³⁺, Sc³⁺, Al³⁺, Be²⁺, P⁵⁺, Mg²⁺, La³⁺, As³⁺, Sr²⁺, Ti⁴⁺, Si²⁺, Fe³⁺, Mo³⁺, Mn²⁺, Si⁴⁺, Ge²⁺, Cr³⁺, As⁰⁺, Mo⁶⁺, V²⁺, As⁻, P³⁺, Co²⁺, Mo⁵⁺, As³⁻, Mo²⁺, As⁻, As²⁺, Ti²⁺, Mo⁴⁺, B²⁺, Fe²⁺, B+, La²⁺, P⁴⁺, As²⁻, B³⁻, Se²⁻, Cr²⁺, Cr⁵⁺, P+, Ge⁴⁺, V⁵⁺, Cr⁴⁺, V⁴⁺.

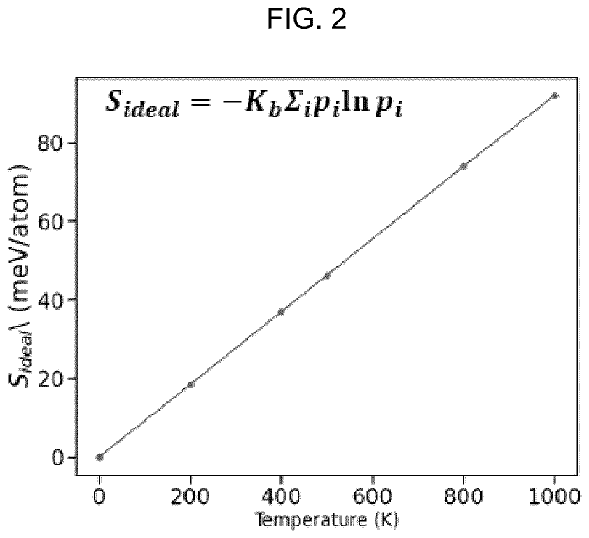

The phase stability of the predicted materials was theoretically calculated by estimating the energy above the linear combination of stable phases in the first principle phase diagram at 0 K, also known as the energy above hull (Eₕᵤₗₗ). The phase diagrams were constructed using energies calculated using DFT, as well as thermodynamic data from the Materials Project using the Materials Application Programming Interface (API). To assert a threshold value beyond which theoretical compositions in the Li₄₋ₓB_{7-y}M_{y}O_{12-z}Cl_{w} chemical spaces are deemed unstable, the ideal configurational entropy is used (S_{ideal}=−K_{b}TΣᵢpᵢ ln pᵢ), where K_{b} is the Boltzmann constant, pᵢ is the probability of each state (occupied or unoccupied) and the sum is over all states for each site. FIG. 2 shows the linear dependence between the ideal configurational temperature and a given experimental temperature. It should be noted that previous reports have suggested that doping the cubic parent structure of Li₄B₇Cl₁₂O with Al³⁺ can be prepared using the melt-quenching-crystallization method, where initial reagent powders were mixed as such: Li₂CO₃:Al₂O₃:B₂O₃:LiCl and melted at 1150° C. As such, it is assumed that ideal configurational entropy at 1000° C. is a valid indicator of the threshold value beyond which computed compounds are deemed unstable. Precisely, according to FIG. 2, which shows the ideal configurational entropy energy (S_{ideal}) vs. temperature in Kelvin when 3 dopants are inserted on the B³⁺ site, that value is set to roughly 110 meV/atom.

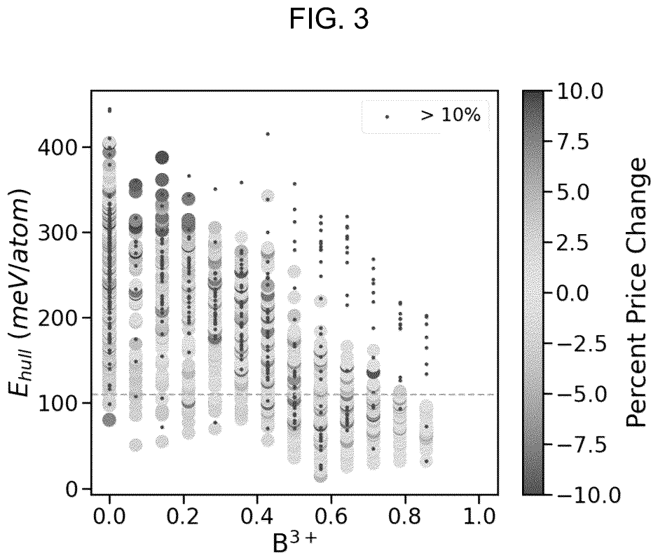

FIG. 3 shows an exemplary embodiment with (A) Eₕᵤₗₗ<100 meV/atom and (B) optimized price difference. In particular, FIG. 3 shows the optimization of low-cost multi-component Li₄₋ₓB_{7-y}M_{y}O_{12-z}Cl_{w} where the compositions' content is tailored to increase configurational entropy, reduce lattice strain and introduce cheaper elements such as Fe. An increase in configurational entropy results in stabilization of higher Eₕᵤₗₗ phases.

Assume the following dummy species:
A with oxidation state of 0+
D with oxidation state 3+/−
X with oxidation state 2+
E with oxidation state 4+
G with oxidation state 5+
Z with oxidation state 6+

### Disclosed Chemical Spaces:

Cl—Li—O-D
Cl—Li—O—X-D-E
Cl—Li—O—X-D-G
Cl—Li—O-A-D-Z
Cl—Li—O-D-Z

The following stoichiometry ranges are disclosed:
D from 0 to 0.86:
   Al³⁺→[0, 0.5]
   B³⁺→ [0, 0.86]
   Fe³⁺, La³⁺, Y³⁺→[0, 0.43]
   Mo³⁺→[0, 0.36]
   Cr³⁺→[0, 0.21]
   As³⁺→[0, 0.86]
   As³⁻→[0, 0.08]
X from 0 to 0.43:
   Be²⁺→[0, 0.43]
   Mn²⁺→[0, 0.22]
   V²⁺/Co²⁺/Fe²⁺→[0, 0.14]
   Ge²⁺/Ti²⁺→[0, 0.07]
E from 0 to 0.43:
   Si⁴⁺→[0, 0.43]
   Mo⁴⁺→[0, 0.14]
Z from 0 to 0.14:
   Mo⁶⁺→[0, 0.14]
G from 0 to 0.14:
   P⁵⁺→[0, 0.14]
A from 0 to 0.14:
   As⁺⁰→[0, 0.14]

In particular, FIG. 3 shows the optimized Li₄₋ₓB_{7-y}M_{y}O_{12-z}Cl_{w} compositions where the thermodynamic stability is progressively screened against the content of B³⁺ when inserting up to 3-species on the B³⁺ site. Overall, a total of 33 unique chemical spaces, i.e., Al—B—Cl—Fe—Li—O, B—Cl—La—Li—O—Y, Al—B—Cl—Li—Mo—O, B—Cl—Fe—Li—Mo—O, etc., present compositions with Eₕᵤₗₗ lower than 110 meV/atom. Table 1 shows a list of representative compositions that fall under the general formula of Li₄₋ₓB_{7-y}M_{y}O_{12-z}Cl_{w}.

TABLE 1
List of representative compositions of the present disclosure

| | | | | | | Price |
|---|---|---|---|---|---|---|
| | | | | | | Change |
| Chemical Space | Composition | Lattice Parameters | Volume | Density | Eₕᵤₗₗ | % |
| Al—B—Cl—Fe—Li—O | Li8Al5FeB8(ClO12)2 | [9.27 9.28 9.27] | 580.22 | 2.25 | 14.25 | −1.25 |
| B—Cl—La—Li—O—Y | Li8La5YB8(ClO12)2 | [9.65 9.65 9.63] | 670.7 | 3.42 | 14.79 | 4.81 |
| Al—B—Cl—Fe—Li—O | Li4Al2FeB4ClO12 | [9.3 9.3 9.3] | 587.16 | 2.31 | 20.73 | −1.43 |
| B—Cl—La—Li—O—Y | Li8La3Y3B8(ClO12)2 | [9.52 9.52 9.52] | 645.4 | 3.29 | 22.78 | 10.44 |
| B—Cl—La—Li—O—Y | Li4LaY2B4ClO12 | [9.46 9.45 9.47] | 633.41 | 3.23 | 25.16 | 13.25 |
| Al—B—Cl—Fe—Li—O | Li8Al4FeB9(ClO12)2 | [9.2 9.15 9.15] | 559.93 | 2.29 | 25.38 | −1.07 |
| B—Cl—La—Li—O—Y | Li8LaY5B8(ClO12)2 | [9.39 9.39 9.41] | 620.74 | 3.16 | 27.06 | 16.06 |
| Al—B—Cl—Fe—Li—O | Li8Al3Fe3B8(ClO12)2 | [9.32 9.31 9.33] | 592.08 | 2.37 | 28.15 | −1.62 |
| Al—B—Cl—Fe—Li—O | Li8Al3FeB10(ClO12)2 | [9.12 8.96 9.11] | 545.22 | 2.3 | 28.98 | −0.9 |
| Al—B—Cl—Li—Mo—O | Li4Al2B4MoClO12 | [9.32 9.32 9.32] | 576.35 | 2.58 | 30.82 | 1.76 |
| Al—B—Cl—Li—O—Y | Li8YAl5B8(ClO12)2 | [9.28 9.29 9.33] | 591.17 | 2.31 | 30.9 | 2.26 |
| Al—B—Cl—Fe—Li—O | Li8Al2FeB11(ClO12)2 | [9.03 8.92 9.05] | 529.48 | 2.32 | 31.63 | −0.72 |
| Al—B—Cl—Fe—Li—O | Li8AlFeB12(ClO12)2 | [8.87 8.88 8.9] | 509.74 | 2.36 | 31.97 | −0.54 |
| B—Cl—La—Li—Mo—O | Li8La5B8Mo(ClO12)2 | [9.57 9.56 9.6] | 668.1 | 3.45 | 32.0 | 2.91 |
| B—Be—Cl—Li—O—Si | Li8BeSiB12(ClO12)2 | [8.73 8.83 8.83] | 483.3 | 2.33 | 32.08 | 82.99 |
| Al—B—Cl—Li—Mo—O | Li8Al5B8Mo(ClO12)2 | [9.34 9.35 9.13] | 579.78 | 2.37 | 32.53 | 0.35 |
| Al—B—Cl—Fe—Li—O | Li8Al3Fe2B9(ClO12)2 | [9.18 9.21 9.22] | 568.1 | 2.34 | 32.92 | −1.26 |
| Al—B—Cl—Cr—Li—O | Li8Al5CrB8(ClO12)2 | [9.26 9.25 9.13] | 572.53 | 2.27 | 33.95 | −0.49 |
| Al—B—Cl—Fe—Li—O | Li4AlFeB5ClO12 | [9.09 9.16 9.14] | 555.74 | 2.34 | 33.97 | −1.08 |
| Al—B—Cl—Fe—Li—O | Li4AlFe2B4ClO12 | [9.34 9.32 9.34] | 596.29 | 2.43 | 34.05 | −1.8 |
| Al—B—Cl—La—Li—O | Li8LaAl5B8(ClO12)2 | [9.35 9.36 9.39] | 602.8 | 2.4 | 35.51 | −0.56 |
| Al—B—Cl—Fe—Li—O | Li8Al6FeB7(ClO12)2 | [9.29 9.43 9.4] | 592.1 | 2.25 | 35.9 | −1.43 |
| Al—B—Cl—Li—O—Y | Li8YAl4B9(ClO12)2 | [9.17 9.19 9.23] | 576.2 | 2.32 | 38.63 | 2.44 |
| Al—B—Cl—Fe—Li—O | Li8AlFe2B11(ClO12)2 | [8.9 9.1 9.1] | 538.91 | 2.37 | 39.19 | −0.9 |
| Al—B—Cl—Fe—Li—O | Li8AlFe5B8(ClO12)2 | [9.34 9.35 9.33] | 600.12 | 2.5 | 40.17 | −1.99 |
| Al—B—Cl—Fe—Li—O | Li8Al2Fe3B9(ClO12)2 | [9.19 9.22 9.23] | 573.32 | 2.4 | 40.94 | −1.44 |
| Al—B—Cl—Fe—Li—O | Li8Al5Fe2B7(ClO12)2 | [9.45 9.32 9.43] | 599.97 | 2.3 | 41.72 | −1.61 |
| Al—B—Cl—Li—O—Y | Li8YAl3B10(ClO12)2 | [8.93 9.04 9.19] | 553.44 | 2.37 | 43.14 | 2.61 |
| Al—B—Cl—Fe—Li—O | Li8AlFe4B9(ClO12)2 | [9.25 9.23 9.26] | 581.48 | 2.45 | 43.99 | −1.62 |
| Al—B—Cl—Cr—Li—O | Li8Al4CrB9(ClO12)2 | [9.21 9.15 9.04] | 554.44 | 2.3 | 44.01 | −0.31 |
| Al—B—Cl—Li—Mo—O | Li8Al6B7Mo(ClO12)2 | [9.32 9.6 9.24] | 590.83 | 2.37 | 44.47 | 0.17 |
| B—Cl—Li—Mo—O—Y | Li8Y5B8Mo(ClO12)2 | [9.25 9.24 9.28] | 607.96 | 3.11 | 44.62 | 16.97 |
| Al—B—Cl—Cr—Li—O | Li8AlCrB12(ClO12)2 | [8.87 8.83 8.76] | 506.53 | 2.36 | 44.81 | 0.22 |
| B—Cl—Fe—La—Li—O | Li8La5FeB8(ClO12)2 | [9.58 9.61 9.67] | 669.9 | 3.34 | 44.85 | 1.31 |
| Al—B—Cl—Fe—Li—O | Li8AlFe3B10(ClO12)2 | [8.97 9.15 9.19] | 559.64 | 2.41 | 45.18 | −1.26 |
| Al—B—Cl—La—Li—O | Li8LaAl4B9(ClO12)2 | [9.24 9.25 9.29] | 586.7 | 2.42 | 45.19 | −0.38 |
| Al—B—Cl—Cr—Li—O | Li8Al3CrB10(ClO12)2 | [9.09 8.81 9.05] | 538.33 | 2.32 | 45.52 | −0.14 |
| Al—B—Cl—Li—Mo—O | Li8AlB12Mo(ClO12)2 | [8.94 8.78 8.8] | 514.3 | 2.46 | 46.41 | 1.06 |
| Al—B—Cl—Li—Mo—O | Li8Al4B9Mo(ClO12)2 | [9.28 9.22 9.02] | 560.41 | 2.4 | 46.55 | 0.53 |
| B—Be—Cl—Li—O—Si | Li4BeSiB5ClO12 | [8.86 8.94 8.86] | 497.01 | 2.31 | 46.8 | 165.98 |
| Al—B—Cl—Li—Mo—O | Li8Al3B10Mo(ClO12)2 | [9.2 8.86 9.09] | 555.44 | 2.38 | 47.53 | 0.7 |
| Al—B—Cl—Cr—Li—O | Li8Al2CrB11(ClO12)2 | [9. 8.97 8.84] | 520.66 | 2.35 | 48.54 | 0.04 |
| Al—B—Cl—Fe—Li—O | Li8Al4Fe3B7(ClO12)2 | [9.45 9.41 9.34] | 603.41 | 2.37 | 48.67 | −1.8 |
| B—Cl—Fe—Li—O—Y | Li8Y5FeB8(ClO12)2 | [9.24 9.33 9.34] | 611.51 | 2.98 | 49.54 | 15.37 |
| Al—As—B—Cl—Li—O | Li8Al5BAs8(ClO12)2 | [10.22 10.4 10.17] | 728.21 | 2.86 | 50.7 | −2.45 |
| Al—B—Cl—Li—O—Y | Li8YAl2B11(ClO12)2 | [8.88 9.14 8.95] | 537.52 | 2.39 | 51.75 | 2.79 |
| Al—B—Cl—Li—O—Y | Li4YAl2B4ClO12 | [9.35 9.25 9.31] | 599.9 | 2.44 | 51.9 | 5.58 |
| B—Cl—Fe—Li—O—Y | Li8YFeB12(ClO12)2 | [8.87 9.01 8.83] | 527.88 | 2.47 | 52.9 | 2.78 |
| B—Cl—Li—Mn—O—Si | Li8MnSiB12(ClO12)2 | [8.97 8.98 8.77] | 508.39 | 2.36 | 53.18 | −0.34 |
| Al—B—Cl—Li—Mo—O | Li8Al2B11Mo(ClO12)2 | [9.06 9.01 8.95] | 529.44 | 2.44 | 53.92 | 0.88 |
| Al—B—Cl—Fe—Li—O | Li8Al3Fe4B7(ClO12)2 | [9.35 9.43 9.5] | 608.54 | 2.43 | 54.5 | −1.98 |
| Al—B—Cl—Li—O—Y | Li8Y2Al3B9(ClO12)2 | [9.2 9.15 9.15] | 586.47 | 2.45 | 54.87 | 5.76 |
| Al—As—B—Cl—Li—O | Li4Al2BAs4ClO12 | [10.08 10.52 10.08] | 715.46 | 2.88 | 54.91 | −2.27 |
| Al—B—Cl—La—Li—O | Li8LaAl3B10(ClO12)2 | [9.03 9.13 9.25] | 563.96 | 2.47 | 55.48 | −0.2 |
| B—Cl—La—Li—Mo—O | Li4La2B4MoClO12 | [9.47 9.43 9.43] | 651.98 | 3.42 | 55.83 | 3.81 |
| Al—B—Cl—Li—Mo—O | Li8Al5B7Mo2(ClO12)2 | [9.55 9.33 9.6] | 595.04 | 2.55 | 55.84 | 1.59 |
| B—Cl—Fe—Li—O—Y | Li4Y2FeB4ClO12 | [9.1 9.35 9.35] | 613.82 | 2.88 | 56.0 | 11.86 |
| Al—B—Cl—Li—Mo—O | Li4AlB5MoClO12 | [9.2 9.15 8.91] | 552.51 | 2.6 | 56.09 | 2.12 |
| Al—B—Cl—Li—O—Y | Li8YAl6B7(ClO12)2 | [9.25 9.21 9.32] | 600.72 | 2.31 | 56.14 | 2.08 |
| Al—B—Cl—Li—O—Y | Li8Y5AlB8(ClO12)2 | [9.32 9.4 9.27] | 620.91 | 2.86 | 56.16 | 15.55 |
| B—Cl—Fe—Li—O—Y | Li8YFe5B8(ClO12)2 | [9.26 9.27 9.42] | 603.91 | 2.65 | 56.2 | 1.34 |
| Al—B—Cl—Fe—Li—O | Li4Al3FeB3ClO12 | [9.64 9.43 9.65] | 619.79 | 2.27 | 56.33 | −1.79 |
| Al—B—Cl—La—Li—O | Li8La5AlB8(ClO12)2 | [9.68 9.74 9.64] | 683.97 | 3.2 | 56.54 | 1.49 |
| B—Cl—Cr—La—Li—O | Li8La5CrB8(ClO12)2 | [9.59 9.56 9.55] | 667.84 | 3.34 | 56.65 | 2.07 |
| Al—B—Cl—Cr—Li—O | Li8Al6CrB7(ClO12)2 | [9.25 9.25 9.36] | 584.6 | 2.27 | 56.66 | −0.67 |
| Al—B—Cl—Cr—Li—O | Li4Al2CrB4ClO12 | [9.29 9.03 9.03] | 573.97 | 2.34 | 56.82 | 0.08 |
| B—Cl—Fe—La—Li—O | Li4La2FeB4ClO12 | [9.45 9.48 9.48] | 651.42 | 3.22 | 57.15 | 0.61 |
| B—Cl—Cr—Fe—Li—O | Li8CrFeB12(ClO12)2 | [8.91 8.77 8.95] | 515.59 | 2.41 | 57.63 | 0.04 |
| B—Cl—Fe—Li—O—Y | Li4YFe2B4ClO12 | [9.19 9.46 9.19] | 609.95 | 2.72 | 57.74 | 4.85 |
| Al—B—Cl—Li—O—Y | Li8Y3Al3B8(ClO12)2 | [9.2 9.51 9.21] | 611.33 | 2.57 | 58.33 | 8.91 |
| B—Cl—Fe—La—Li—O | Li8LaFe5B8(ClO12)2 | [9.28 9.29 9.48] | 610.17 | 2.76 | 58.48 | −1.47 |
| B—Cl—Li—Mo—O—Y | Li8YB12Mo(ClO12)2 | [8.96 8.85 8.81] | 526.29 | 2.6 | 58.53 | 4.38 |
| B—Cl—Li—Mo—O—Y | Li4Y2B4MoClO12 | [9.15 9.17 9.17] | 605.45 | 3.14 | 58.78 | 15.06 |
| Al—B—Cl—La—Li—O | Li4LaAl2B4ClO12 | [9.43 9.36 9.49] | 624.04 | 2.61 | 60.1 | −0.04 |
| B—Cl—Li—Mo—O—Y | Li8Y3B8Mo3(ClO12)2 | [9. 9.15 9.04] | 603.24 | 3.17 | 60.42 | 13.15 |
| B—Cl—Fe—La—Li—O | Li8La3Fe3B8(ClO12)2 | [9.33 9.57 9.24] | 638.19 | 3.07 | 60.43 | −0.08 |
| Al—B—Cl—Fe—Li—O | Li8Al2Fe5B7(ClO12)2 | [9.46 9.49 9.36] | 612.06 | 2.49 | 60.59 | −2.16 |
| Al—B—Cl—La—Li—O | Li8LaAl2B11(ClO12)2 | [8.93 9.15 8.98] | 542.66 | 2.52 | 60.72 | −0.02 |
| Al—B—Cl—Cr—Li—O | Li8Al3Cr2B9(ClO12)2 | [9.18 8.98 8.9] | 557.57 | 2.36 | 60.78 | 0.26 |
| Al—B—Cl—Li—Mo—O | Li8Al3B9Mo2(ClO12)2 | [9.26 9.22 9.04] | 565.17 | 2.59 | 60.91 | 1.94 |
| B—Cl—Li—O—Si—V | Li8VSiB12(ClO12)2 | [8.9 8.79 8.96] | 500.71 | 2.39 | 61.12 | 1.72 |
| Al—B—Cl—La—Li—O | Li8LaAl6B7(ClO12)2 | [9.3 9.26 9.38] | 609.95 | 2.41 | 61.17 | −0.73 |
| B—Cl—La—Li—Mo—O | Li8La3B8Mo3(ClO12)2 | [9.3 9.44 9.35] | 642.13 | 3.37 | 61.43 | 4.71 |
| B—Cl—Fe—Li—Mo—O | Li8Fe3B10Mo(ClO12)2 | [8.97 9.18 9.01] | 556.55 | 2.63 | 61.75 | 0.15 |
| Al—B—Cl—Cr—Li—O | Li4AlCrB5ClO12 | [9.09 9.15 8.76] | 540.79 | 2.38 | 61.76 | 0.44 |
| B—Cl—Fe—Li—O—Y | Li8Y3Fe3B8(ClO12)2 | [9.15 9.4 9.22] | 609.38 | 2.81 | 62.01 | 8.35 |
| B—Cl—Co—Li—O—Si | Li8CoSiB12(ClO12)2 | [8.95 8.95 8.76] | 503.92 | 2.4 | 62.07 | 5.43 |
| B—Cl—Fe—Li—Mo—O | Li8Fe5B8Mo(ClO12)2 | [9.23 9.33 9.19] | 598.13 | 2.7 | 62.38 | −0.57 |
| B—Cl—Fe—Li—O—Y | Li4YFeB5ClO12 | [9.01 9.37 8.79] | 570.82 | 2.64 | 62.62 | 5.57 |
| B—Cl—Fe—La—Li—O | Li4LaFe2B4ClO12 | [9.19 9.62 9.19] | 621.28 | 2.93 | 62.78 | −0.78 |
| B—Be—Cl—Li—O—Si | Li8Be3Si3B8(ClO12)2 | [9.01 9.04 8.98] | 516.11 | 2.28 | 63.11 | 248.97 |
| B—Cl—Fe—Li—O—Y | Li8YFe2B11(ClO12)2 | [8.96 9.24 8.97] | 557.48 | 2.47 | 63.28 | 2.42 |
| B—Cl—Li—Mn—O—Si | Li4MnSiB5ClO12 | [8.94 9.34 9.27] | 563.91 | 2.31 | 63.97 | −0.68 |
| B—Cl—La—Li—Mo—O | Li8LaB12Mo(ClO12)2 | [9.04 8.93 8.89] | 540.13 | 2.69 | 64.79 | 1.57 |
| Al—As—B—Cl—Li—O | Li8Al3B3As8(ClO12)2 | [9.97 9.81 10.11] | 685.58 | 2.96 | 65.03 | −2.09 |
| B—Cl—Fe—Li—Mo—O | Li8Fe2B11Mo(ClO12)2 | [8.92 9.16 8.94] | 548.68 | 2.53 | 65.04 | 0.51 |
| B—Cl—Cr—Li—O—Y | Li8YCrB12(ClO12)2 | [8.86 8.97 8.8] | 526.65 | 2.46 | 65.61 | 3.54 |
| Al—B—Cl—Li—O—Y | Li4YAlB5ClO12 | [8.94 9.44 9.06] | 569.74 | 2.48 | 65.82 | 5.94 |
| Al—B—Cl—Fe—Li—O | Li8AlFe6B7(ClO12)2 | [9.38 9.48 9.51] | 615.46 | 2.56 | 65.98 | −2.35 |
| B—Cl—Fe—Li—O—Y | Li8YFe4B9(ClO12)2 | [9.19 9.3 9.17] | 583.71 | 2.62 | 66.87 | 1.7 |
| B—Cl—Fe—Li—O—Y | Li8Y2Fe3B9(ClO12)2 | [9.15 9.35 9.25] | 597.62 | 2.65 | 67.12 | 5.21 |
| Al—B—Cl—La—Li—O | Li8La2Al3B9(ClO12)2 | [9.33 9.28 9.37] | 611.94 | 2.62 | 67.45 | 0.13 |
| Al—B—Cl—Li—O—Y | Li8Y4AlB9(ClO12)2 | [9.89 9.02 9.08] | 621.52 | 2.65 | 67.96 | 12.41 |
| Al—As—B—Cl—Li—O | Li8AlB12As(ClO12)2 | [8.8 9.17 8.99] | 507.63 | 2.43 | 68.62 | −0.37 |
| Al—B—Cl—La—Li—O | Li8La3Al3B8(ClO12)2 | [9.47 9.68 9.51] | 652.42 | 2.79 | 68.73 | 0.47 |
| Al—B—Cl—Li—O—Y | Li8YAlB12(ClO12)2 | [8.83 9.36 8.86] | 520.33 | 2.41 | 69.07 | 2.97 |
| B—Cl—Cr—Li—O—Y | Li8Y5CrB8(ClO12)2 | [9.26 9.25 9.25] | 600.8 | 3.02 | 69.13 | 16.13 |
| B—Cl—Fe—La—Li—O | Li8LaFeB12(ClO12)2 | [8.94 9.06 8.88] | 538.47 | 2.57 | 69.13 | −0.03 |
| B—Cl—Fe—La—Li—O | Li8LaFe4B9(ClO12)2 | [9.21 9.39 9.19] | 591.06 | 2.73 | 69.66 | −1.11 |
| Al—B—Cl—Li—O—Y | Li8Y2AlB11(ClO12)2 | [8.87 9.46 8.82] | 554.4 | 2.5 | 69.88 | 6.11 |
| Al—As—B—Cl—Li—O | Li4AlB2As4ClO12 | [10.04 9.65 10.04] | 665.98 | 3.01 | 69.94 | −1.91 |
| B—Cl—Fe—Li—O—Y | Li8YFe3B10(ClO12)2 | [8.9 9.29 9.14] | 571.37 | 2.54 | 70.1 | 2.06 |
| B—Cl—La—Li—O—Y | Li8La3Y4B7(ClO12)2 | [9.61 9.57 9.56] | 658.03 | 3.43 | 70.1 | 13.59 |
| B—Cl—La—Li—O—Y | Li8LaY2B11(ClO12)2 | [8.81 10.07 8.78] | 596.8 | 2.63 | 70.24 | 6.63 |
| B—Be—Cl—Li—O—Si | Li4Be2Si2B3ClO12 | [9.16 9.16 9.01] | 530.89 | 2.26 | 70.31 | 331.96 |
| B—Cl—La—Li—O—Y | Li8La6YB7(ClO12)2 | [9.73 9.72 9.73] | 699.41 | 3.58 | 70.65 | 5.15 |
| As—B—Cl—Fe—Li—O | Li8FeB12As(ClO12)2 | [8.99 8.79 8.92] | 525.0 | 2.44 | 70.69 | −0.56 |
| B—Cl—Li—Mo—O—Y | Li4YB4Mo2ClO12 | [9. 9.039.] | 597.46 | 3.22 | 70.83 | 11.24 |
| As—B—Cl—Fe—Li—O | Li8Fe6B7As(ClO12)2 | [9.29 9.29 9.29] | 612.98 | 2.7 | 71.34 | −2.36 |
| As—B—Cl—Fe—Li—O | Li8Fe2B11As(ClO12)2 | [8.82 9.17 9.13] | 544.73 | 2.49 | 71.73 | −0.92 |
| B—Be—Cl—Li—O—Si | Li4Be3Si3BClO12 | [9.37 9.37 9.37] | 570.86 | 2.2 | 71.89 | 497.94 |
| Al—B—Cl—Fe—Li—O | Li4Al2Fe2B3ClO12 | [9.44 9.66 9.68] | 627.35 | 2.4 | 72.34 | −2.16 |
| B—Cl—Fe—Li—Mo—O | Li8Fe4B9Mo(ClO12)2 | [9.12 9.32 9.01] | 583.95 | 2.64 | 72.61 | −0.21 |
| As—B—Cl—Fe—Li—O | Li8Fe3B10As(ClO12)2 | [9.19 8.93 9.29] | 568.98 | 2.51 | 72.73 | −1.28 |
| B—Cl—Fe—La—Li—O | Li4LaFeB5ClO12 | [9.02 9.52 8.83] | 596.45 | 2.81 | 72.74 | −0.06 |
| B—Cl—Ge—Li—O—Si | Li8SiGeB12(ClO12)2 | [9.08 9.02 8.68] | 505.26 | 2.43 | 72.82 | 183.58 |
| Al—B—Cl—Fe—Li—O | Li8Al5Fe3B6(ClO12)2 | [9.48 9.5 9.51] | 615.35 | 2.37 | 72.88 | −1.97 |
| Al—B—Cl—Li—Mo—O | Li8Al3B8Mo3(ClO12)2 | [9.47 8.96 9.35] | 592.94 | 2.7 | 73.32 | 3.18 |
| B—Cl—Li—Mn—O—Si | Li8Mn3Si3B8(ClO12)2 | [9.26 9.44 9.42] | 608.33 | 2.31 | 73.38 | −1.02 |
| B—Cl—Fe—Li—Mo—O | Li8FeB12Mo(ClO12)2 | [9.06 8.77 8.99] | 524.84 | 2.51 | 73.84 | 0.88 |
| B—Cl—Fe—La—Li—O | Li8LaFe2B11(ClO12)2 | [9.01 9.28 9.06] | 565.77 | 2.58 | 74.03 | −0.39 |
| B—Cl—Li—Mo—O—Y | Li8YB8Mo5(ClO12)2 | [9.05 8.89 8.94] | 590.33 | 3.28 | 74.15 | 9.33 |
| B—Cl—Cr—La—Li—O | Li8LaCrB12(ClO12)2 | [8.94 9.02 8.86] | 536.84 | 2.57 | 74.17 | 0.73 |
| Al—B—Cl—Li—O—Y | Li8Y2Al5B7(ClO12)2 | [9.38 9.12 9.26] | 611.94 | 2.44 | 74.56 | 5.4 |
| B—Cl—Fe—Li—O—Y | Li8Y4FeB9(ClO12)2 | [8.94 9.23 9.59] | 615.56 | 2.75 | 74.64 | 12.22 |
| B—Cl—La—Li—O—Y | Li8La2YB11(ClO12)2 | [8.76 10.19 8.85] | 608.13 | 2.72 | 74.75 | 3.81 |
| B—Cl—Fe—La—Li—O | Li8LaFe3B10(ClO12)2 | [8.93 9.36 9.2] | 579.77 | 2.65 | 75.06 | −0.75 |
| As—B—Cl—Li—O—Y | Li4YB3As3ClO12 | [9.35 9.65 9.65] | 681.12 | 2.93 | 75.28 | 5.12 |
| Al—B—Cl—Cr—Li—O | Li8AlCr2B11(ClO12)2 | [8.93 8.99 8.78] | 528.42 | 2.39 | 75.73 | 0.62 |
| B—Cl—Fe—La—Li—O | Li8La2Fe3B9(ClO12)2 | [9.17 9.48 9.36] | 615.16 | 2.84 | 75.79 | −0.42 |
| Al—B—Cl—Li—O—Y | Li8YAl7B6(ClO12)2 | [9.17 9.14 9.29] | 618.69 | 2.29 | 76.0 | 1.9 |
| Al—B—Cl—La—Li—O | Li8LaAlB12(ClO12)2 | [8.92 9.43 8.88] | 527.99 | 2.53 | 76.28 | 0.16 |
| B—Cl—La—Li—O—Y | Li8La2Y5B7(ClO12)2 | [9.52 9.53 9.52] | 652.34 | 3.33 | 76.55 | 16.4 |
| B—Cl—La—Li—Mo—O | Li8LaB8Mo5(ClO12)2 | [9.22 9.12 9.03] | 607.41 | 3.32 | 76.81 | 6.52 |
| B—Cl—Cr—La—Li—O | Li4La2CrB4ClO12 | [9.42 9.31 9.31] | 640.57 | 3.26 | 76.86 | 2.13 |
| B—Cl—La—Li—Mo—O | Li4LaB4Mo2ClO12 | [9.2 9.23 9.2] | 623.44 | 3.35 | 77.09 | 5.62 |
| B—Cl—La—Li—Mo—O | Li8La5B7Mo2(ClO12)2 | [9.49 9.35 9.41] | 663.75 | 3.68 | 77.2 | 4.14 |
| B—Cl—La—Li—O—Y | Li8La3Y2B9(ClO12)2 | [9.84 9.31 9.34] | 661.95 | 3.02 | 77.28 | 7.29 |
| B—Cl—Li—Mo—O—Y | Li8Y4B9Mo(ClO12)2 | [9.01 8.96 9.68] | 615.93 | 2.86 | 77.29 | 13.82 |
| As—B—Cl—Fe—Li—O | Li8Fe2B3As9(ClO12)2 | [10.5 9.32 9.18] | 737.05 | 2.99 | 77.31 | −2.48 |
| B—Be—Cl—Li—O—Si | Li8Be5Si5B4(ClO12)2 | [9.25 9.14 9.28] | 557.62 | 2.2 | 77.58 | 414.95 |
| B—Cl—Fe—La—Li—O | Li8La5Fe2B7(ClO12)2 | [9.34 9.23 9.51] | 651.79 | 3.55 | 77.84 | 0.94 |
| B—Cl—Fe—Li—O—Y | Li8Y3Fe2B9(ClO12)2 | [9.17 9.32 9.09] | 599.09 | 2.73 | 77.9 | 8.72 |
| Al—B—Cl—La—Li—O | Li8LaAl7B6(ClO12)2 | [9.21 9.21 9.35] | 631.15 | 2.38 | 77.98 | −0.91 |
| Al—B—Cl—Cr—Li—O | Li8Al3Cr3B8(ClO12)2 | [9.39 8.77 9.31] | 572.8 | 2.42 | 78.21 | 0.66 |
| Al—B—Cl—Li—Mo—O | Li8AlB10Mo3(ClO12)2 | [8.91 8.61 9.21] | 559.39 | 2.77 | 78.25 | 3.53 |
| Al—B—Cl—Cr—Li—O | Li8Al5Cr2B7(ClO12)2 | [9.46 9.19 9.14] | 588.01 | 2.33 | 78.28 | −0.09 |
| B—Cl—La—Li—O—Y | Li8La5Y2B7(ClO12)2 | [9.64 9.66 9.66] | 695.6 | 3.48 | 78.47 | 7.96 |
| Al—B—Cl—Li—Mo—O | Li4AlB4Mo2ClO12 | [9.3 8.82 9.3] | 588.85 | 2.92 | 78.49 | 4.59 |
| As—B—Cl—Fe—Li—O | Li8FeB11As2(ClO12)2 | [9.04 8.93 9.04] | 554.69 | 2.5 | 78.7 | −0.75 |
| Al—As—Cl—Li—O—Y | Li8YAl5As8(ClO12)2 | [9.59 9.82 9.53] | 722.59 | 3.06 | 78.95 | 0.7 |
| B—Cl—Fe—La—Li—O | Li8La3Fe2B9(ClO12)2 | [9.32 9.43 9.09] | 627.16 | 3.01 | 79.41 | 0.28 |
| B—Cl—La—Li—O—Y | Li8LaY4B9(ClO12)2 | [9.58 9.23 9.48] | 637.96 | 2.87 | 79.47 | 12.92 |
| Al—B—Cl—Li—O—Y | Li8Y3Al4B7(ClO12)2 | [9.18 9.46 9.16] | 628.28 | 2.54 | 79.54 | 8.73 |
| Al—B—Cl—Li—O—Y | Li8Y3Al2B9(ClO12)2 | [9.56 9.13 9.25] | 600.11 | 2.57 | 79.72 | 9.08 |
| B—Cl—La—Li—O—Y | Li8LaY6B7(ClO12)2 | [9.47 9.46 9.47] | 644.54 | 3.24 | 79.75 | 19.21 |
| As—B—Cl—La—Li—O | Li4LaB3As3ClO12 | [9.19 10.12 10.12] | 710.05 | 3.05 | 79.95 | −0.5 |
| Al—As—Cl—Li—O—Y | Li8Y3Al3As8(ClO12)2 | [9.85 10.21 9.08] | 748.69 | 3.23 | 80.26 | 7.35 |
| B—Cl—Cr—La—Li—O | Li8La3Cr3B8(ClO12)2 | [9.06 9.43 9.08] | 622.24 | 3.12 | 80.4 | 2.19 |
| Al—As—B—Cl—Li—O | Li8Al7B6As(ClO12)2 | [9.23 9.06 9.18] | 610.05 | 2.28 | 80.49 | −1.44 |
| B—Cl—Fe—Li—O—Y | Li8Y2Fe5B7(ClO12)2 | [8.81 10.03 9.2] | 610.15 | 2.84 | 80.55 | 4.48 |
| Al—As—B—Cl—Li—O | Li8Al2B11As(ClO12)2 | [8.82 9.32 9.29] | 519.15 | 2.43 | 80.56 | −0.55 |
| Al—As—B—Cl—Li—O | Li8AlB5As8(ClO12)2 | [9.93 9.74 9.94] | 645.7 | 3.06 | 81.02 | −1.74 |
| Al—B—Cl—La—Li—O | Li8La4AlB9(ClO12)2 | [10.18 9.32 9.37] | 675.56 | 2.93 | 81.04 | 1.16 |
| As—B—Cl—Fe—Li—O | Li8Fe5B8As(ClO12)2 | [9.31 9.23 9.41] | 606.69 | 2.6 | 81.21 | −2.0 |
| B—Cl—La—Li—O—Y | Li8La2Y3B9(ClO12)2 | [9.65 9.29 9.57] | 649.03 | 2.95 | 81.8 | 10.11 |
| Al—B—Cl—Li—Mo—O | Li4Al3B3MoClO12 | [9.66 9.42 9.83] | 620.7 | 2.49 | 81.81 | 1.41 |
| B—Cl—La—Li—O—Y | Li8La4YB9(ClO12)2 | [9.86 9.45 9.45] | 674.46 | 3.08 | 82.05 | 4.48 |
| Al—B—Cl—La—Li—O | Li4LaAlB5ClO12 | [9.08 9.37 9.32] | 590.1 | 2.67 | 82.45 | 0.31 |
| B—Cl—Li—Mo—O—Y | Li8YB11Mo2(ClO12)2 | [9. 9.15 8.68] | 556.38 | 2.72 | 82.74 | 5.62 |
| B—Cl—La—Li—Mo—O | Li8La4B9Mo(ClO12)2 | [9.3 9.4 9.68] | 662.88 | 3.15 | 82.94 | 2.57 |
| As—B—Cl—Cr—Li—O | Li8CrB11As2(ClO12)2 | [9.03 8.92 8.91] | 548.58 | 2.52 | 82.96 | 0.01 |
| B—Cl—La—Li—Mo—O | Li8La3B9Mo2(ClO12)2 | [9.45 9.45 9.19] | 646.37 | 3.12 | 83.0 | 3.48 |
| B—Cl—Fe—Li—O—Y | Li8Y2FeB11(ClO12)2 | [9.13 9.08 8.83] | 560.78 | 2.56 | 83.49 | 5.93 |
| As—B—Cl—Cr—Li—O | Li8CrB12As(ClO12)2 | [8.9 8.8 8.8] | 523.14 | 2.43 | 83.74 | 0.2 |
| As—B—Cl—Fe—Li—O | Li4Fe2B4AsClO12 | [9.11 9.74 9.11] | 610.84 | 2.64 | 83.87 | −1.84 |
| As—B—Cl—Cr—Li—O | Li8Cr2B11As(ClO12)2 | [8.87 9.09 8.96] | 541.04 | 2.48 | 84.49 | 0.6 |
| Al—B—Cl—Fe—Li—O | Li4AlFe3B3ClO12 | [9.47 9.69 9.69] | 635.01 | 2.52 | 84.83 | −2.53 |
| B—Cl—Fe—La—Li—O | Li8La4FeB9(ClO12)2 | [9.36 9.56 9.8] | 665.3 | 3.04 | 85.24 | 0.97 |
| Al—B—Cl—Li—O—Y | Li8Y3AlB10(ClO12)2 | [9.1 9.3 9.24] | 585.76 | 2.59 | 85.36 | 9.26 |
| B—Cl—Li—Mo—O—Y | Li8Y3B9Mo2(ClO12)2 | [9.27 9.24 9.] | 609.62 | 2.9 | 85.4 | 11.91 |
| B—Cl—Fe—Li—O—Y | Li8Y5Fe2B7(ClO12)2 | [9.21 9.03 9.18] | 610.21 | 3.11 | 85.57 | 15.01 |
| Al—As—B—Cl—Li—O | Li8Al3BAs10(ClO12)2 | [9.33 9.78 9.8] | 743.08 | 3.02 | 85.58 | −2.48 |
| Al—B—Cl—La—Li—O | Li8La2Al5B7(ClO12)2 | [9.46 9.27 9.48] | 635.18 | 2.61 | 86.22 | −0.22 |
| As—B—Cl—Fe—Li—O | Li4Fe2BAs4ClO12 | [9.91 9.91 9.16] | 717.23 | 3.14 | 86.29 | −3.01 |
| B—Cl—Fe—Li—O—Y | Li8Y3FeB10(ClO12)2 | [8.92 8.98 9.4] | 590.81 | 2.65 | 86.31 | 9.08 |
| B—Cl—Cr—Li—Mo—O | Li8CrB12Mo(ClO12)2 | [8.88 8.82 8.86] | 523.33 | 2.5 | 86.54 | 1.64 |
| As—B—Cl—Fe—Li—O | Li8Fe5B5As4(ClO12)2 | [9.27 9.9 9.15] | 644.03 | 2.95 | 86.67 | −2.59 |
| As—B—Cl—Fe—Li—O | Li8Fe5B6As3(ClO12)2 | [9.19 9.6 9.36] | 631.63 | 2.84 | 86.77 | −2.39 |
| Al—B—Cl—Li—Mo—O | Li8Al4B7Mo3(ClO12)2 | [9.43 9.57 9.28] | 603.99 | 2.7 | 86.77 | 3.0 |
| B—Cl—Li—Mo—O—Y | Li8Y2B9Mo3(ClO12)2 | [8.96 9.53 8.76] | 602.45 | 2.96 | 86.99 | 10.01 |
| B—Cl—La—Li—O—Y | Li8La4Y3B7(ClO12)2 | [9.63 9.59 9.59] | 686.26 | 3.41 | 87.1 | 10.77 |
| B—Cl—Fe—Li—Mo—O | Li4FeB5MoClO12 | [9.25 9.25 8.66] | 563.37 | 2.72 | 87.6 | 1.75 |
| B—Cl—La—Li—Mo—O | Li8La6B7Mo(ClO12)2 | [9.4 9.85 10.02] | 708.28 | 3.55 | 87.7 | 3.24 |
| Al—B—Cl—La—Li—O | Li8La3Al4B7(ClO12)2 | [9.4 9.54 9.39] | 662.32 | 2.78 | 87.76 | 0.29 |
| As—B—Cl—Fe—Li—O | Li8Fe6B3As5(ClO12)2 | [9.94 9.19 9.43] | 670.56 | 3.1 | 87.83 | −3.14 |
| Al—B—Cl—Li—Mo—O | Li8Al2B9Mo3(ClO12)2 | [9.46 8.88 8.96] | 578.9 | 2.72 | 87.85 | 3.36 |
| B—Cl—La—Li—O—Y | Li4LaYB5ClO12 | [8.92 9.1 9.73] | 624.79 | 2.85 | 88.11 | 6.96 |
| Al—B—Cl—La—Li—O | Li8La2AlB11(ClO12)2 | [8.94 9.64 8.93] | 580.13 | 2.67 | 88.22 | 0.49 |
| As—B—Cl—Fe—Li—O | Li4Fe3BAs3ClO12 | [10.12 9.32 9.32] | 684.73 | 3.19 | 88.26 | −3.34 |
| Al—B—Cl—Fe—Li—O | Li8Al3Fe5B6(ClO12)2 | [9.51 9.63 9.52] | 625.07 | 2.49 | 88.29 | −2.34 |
| As—B—Cl—Fe—Li—O | Li8Fe4B9As(ClO12)2 | [9.22 9.31 9.17] | 587.27 | 2.56 | 88.49 | −1.64 |
| Al—B—Cl—Li—Mo—O | Li8AlB11Mo2(ClO12)2 | [8.99 8.94 8.83] | 546.28 | 2.58 | 88.67 | 2.3 |
| B—Cl—Cr—Li—O—Y | Li4Y2CrB4ClO12 | [9.15 9.08 9.08] | 594.71 | 2.95 | 88.74 | 13.38 |
| Al—B—Cl—Li—O—Y | Li4YAl3B3ClO12 | [9.35 9. 9.27] | 640.15 | 2.37 | 89.13 | 5.23 |
| As—B—Cl—Fe—Li—O | Li8Fe4B3As7(ClO12)2 | [9.49 10.16 9.26] | 704.54 | 3.04 | 89.7 | −2.81 |
| Al—B—Cl—Li—Mo—O | Li8AlB9Mo4(ClO12)2 | [9.33 8.74 9.27] | 576.64 | 2.93 | 89.81 | 4.77 |
| B—Cl—Li—Mo—O—Y | Li4YB5MoClO12 | [9.3 9.52 8.75] | 578.91 | 2.83 | 89.83 | 8.77 |
| As—B—Cl—Fe—Li—O | Li4FeB2As4ClO12 | [10.04 9.36 9.36] | 719.53 | 2.92 | 90.21 | −2.28 |
| As—B—Cl—Cr—Li—O | Li8Cr3B10As(ClO12)2 | [8.67 9.05 9.14] | 545.71 | 2.58 | 90.37 | 1.0 |
| Al—B—Cl—Cr—Li—O | Li8Al2Cr3B9(ClO12)2 | [9.18 9. 9.07] | 553.32 | 2.45 | 90.4 | 0.84 |
| As—B—Cl—Fe—Li—O | Li8Fe5B7As2(ClO12)2 | [9.39 9.29 9.37] | 622.79 | 2.71 | 90.45 | −2.2 |
| B—Cl—Fe—La—Li—O | Li8La3Fe4B7(ClO12)2 | [8.93 9.81 9.25] | 645.01 | 3.16 | 90.63 | −0.45 |
| As—B—Cl—Fe—Li—O | Li8Fe5B2As7(ClO12)2 | [9.92 9.18 9.77] | 698.44 | 3.18 | 91.1 | −3.17 |
| As—B—Cl—Fe—Li—O | Li8Fe6B5As3(ClO12)2 | [9.48 9.46 9.23] | 645.58 | 2.89 | 91.14 | −2.75 |
| B—Cl—Fe—La—Li—O | Li8La6FeB7(ClO12)2 | [9.43 9.93 10.06] | 706.17 | 3.47 | 91.15 | 1.64 |
| B—Cl—Cr—La—Li—O | Li8La4CrB9(ClO12)2 | [9.28 9.31 9.66] | 653.51 | 3.09 | 91.4 | 1.73 |
| As—B—Cl—Fe—Li—O | Li8Fe3B9As2(ClO12)2 | [9.26 9.02 9.41] | 597.98 | 2.57 | 91.82 | −1.47 |
| B—Cl—Cr—Li—Mo—O | Li8CrB8Mo5(ClO12)2 | [8.95 8.92 8.95] | 579.27 | 3.24 | 91.83 | 6.59 |
| As—B—Cl—Fe—Li—O | Li4Fe3B3AsClO12 | [9.33 9.33 9.33] | 630.21 | 2.79 | 91.86 | −2.56 |
| B—Cl—Cr—Li—O—Y | Li8Y4CrB9(ClO12)2 | [9.01 9.06 9.5] | 608.33 | 2.77 | 91.87 | 12.98 |
| B—Cl—La—Li—Mo—O | Li8LaB11Mo2(ClO12)2 | [9.06 9.33 8.85] | 574.49 | 2.78 | 92.06 | 2.81 |
| B—Cl—Cr—Li—Mo—O | Li8CrB11Mo2(ClO12)2 | [8.73 9.15 8.81] | 543.51 | 2.67 | 92.34 | 2.87 |
| As—B—Cl—Li—Mo—O | Li8B11Mo2As(ClO12)2 | [9.02 9. 8.77] | 553.95 | 2.69 | 92.55 | 2.28 |
| As—B—Cl—Li—Mo—O | Li8B12MoAs(ClO12)2 | [8.96 8.83 8.81] | 533.12 | 2.53 | 92.76 | 1.04 |
| B—Cl—Li—O—Si—Ti | Li8TiSiB12(ClO12)2 | [8.91 8.97 8.82] | 501.49 | 2.37 | 93.02 | −0.17 |
| B—Cl—Cr—La—Li—O | Li8La3Cr2B9(ClO12)2 | [9.24 9.39 9.1] | 623.26 | 3.01 | 93.12 | 1.8 |
| B—Cl—Fe—Li—O—P | Li8Fe2B11P(ClO12)2 | [8.82 9.35 9.15] | 544.76 | 2.35 | 93.15 | 29.04 |
| B—Cl—Fe—La—Li—O | Li8La4Fe3B7(ClO12)2 | [9.3 10. 9.07] | 663.26 | 3.28 | 93.29 | 0.25 |
| As—B—Cl—Fe—Li—O | Li8Fe3B3As8(ClO12)2 | [9.23 10.42 9.16] | 713.19 | 3.05 | 93.64 | −2.64 |
| B—Cl—Cr—Li—O—Y | Li4YCrB5ClO12 | [9.18 9.37 8.56] | 572.24 | 2.61 | 93.66 | 7.09 |
| Al—B—Cl—Cr—Li—O | Li4Al3CrB3ClO12 | [9.68 9.31 9.45] | 608.52 | 2.3 | 93.87 | −0.27 |
| B—Cl—La—Li—Mo—O | Li8LaB9Mo4(ClO12)2 | [9.32 8.72 9.42] | 608.39 | 3.09 | 94.0 | 5.28 |
| As—B—Cl—Fe—Li—O | Li4FeB5AsClO12 | [8.8 9.28 9.16] | 568.4 | 2.57 | 94.01 | −1.11 |
| B—Cl—Fe—Li—Mo—O | Li4FeB4Mo2ClO12 | [9.36 9. 9.] | 591.45 | 3.07 | 94.24 | 4.23 |
| B—Cl—Fe—Li—O—Y | Li8Y6FeB7(ClO12)2 | [9.04 9.6 9.58] | 640.07 | 3.05 | 94.37 | 18.52 |
| Al—B—Cl—Cr—Li—O | Li8AlCr3B10(ClO12)2 | [8.84 8.78 9.12] | 548.66 | 2.43 | 94.43 | 1.02 |
| B—Cl—Li—Mo—O—Y | Li8Y3B10Mo(ClO12)2 | [8.99 8.97 9.16] | 594.24 | 2.74 | 94.53 | 10.68 |
| As—B—Cl—Fe—Li—O | Li8Fe3B6As5(ClO12)2 | [9.2 9.87 9.13] | 656.34 | 2.83 | 94.78 | −2.06 |
| As—B—Cl—Fe—Li—O | Li8Fe4B5As5(ClO12)2 | [9.31 9.73 9.19] | 652.43 | 2.96 | 94.88 | −2.42 |
| B—Cl—Cr—Li—O—Y | Li8Y3Cr2B9(ClO12)2 | [9.13 9.19 8.97] | 588.84 | 2.76 | 94.95 | 10.23 |
| As—B—Cl—Li—O—Y | Li8YB12As(ClO12)2 | [8.76 9.55 8.95] | 525.63 | 2.54 | 95.03 | 2.95 |
| B—Cl—Cr—Li—O—Y | Li8YCr2B11(ClO12)2 | [8.84 9.37 8.94] | 549.15 | 2.49 | 95.05 | 3.94 |
| B—Cl—Cr—Li—O—Y | Li8Y2CrB11(ClO12)2 | [9.07 9.22 8.74] | 565.68 | 2.52 | 95.21 | 6.69 |
| B—Cl—La—Li—O—Y | Li8LaYB12(ClO12)2 | [8.86 9.83 8.83] | 540.75 | 2.67 | 95.27 | 3.48 |
| Al—As—B—Cl—Li—O | Li8AlBAs12(ClO12)2 | [10.31 9.8 9.78] | 771.53 | 3.11 | 95.49 | −2.52 |
| B—Cl—Cr—La—Li—O | Li8La5Cr2B7(ClO12)2 | [9.35 9.25 9.37] | 644.45 | 3.57 | 95.54 | 2.46 |
| As—B—Cl—Fe—Li—O | Li8Fe3B8As3(ClO12)2 | [9.69 9.14 8.97] | 616.04 | 2.67 | 95.79 | −1.67 |
| Al—As—B—Cl—Li—O | Li8AlB11As2(ClO12)2 | [8.93 9.06 9.02] | 547.41 | 2.45 | 95.92 | −0.57 |
| B—Cl—Fe—Li—O—Y | Li8YFe6B7(ClO12)2 | [9.31 9.45 9.59] | 616.69 | 2.72 | 96.14 | 0.98 |
| B—Cl—Li—O—Si—V | Li4VSiB5ClO12 | [9.14 9.17 9.03] | 562.58 | 2.29 | 96.24 | 3.45 |
| As—B—Cl—Fe—Li—O | Li4Fe2B2As3ClO12 | [9.55 9.66 9.66] | 693.82 | 2.94 | 96.35 | −2.62 |
| B—Cl—Fe—La—Li—O | Li8LaFe6B7(ClO12)2 | [9.3 9.46 9.64] | 623.93 | 2.82 | 96.38 | −1.84 |
| B—Cl—Cr—Li—O—Y | Li8Y3Cr3B8(ClO12)2 | [8.98 9.11 9.04] | 587.35 | 2.88 | 96.43 | 10.63 |
| As—B—Cl—La—Li—O | Li8LaB12As(ClO12)2 | [8.76 9.73 8.98] | 533.41 | 2.66 | 96.45 | 0.14 |
| As—B—Cl—Fe—Li—O | Li4Fe2B3As2ClO12 | [9.11 9.69 9.33] | 640.86 | 2.85 | 96.48 | −2.23 |
| B—Cl—Fe—La—Li—O | Li8La2FeB11(ClO12)2 | [9.08 9.13 8.93] | 580.32 | 2.76 | 96.52 | 0.31 |
| B—Cl—Li—Mo—O—Y | Li8Y6B7Mo(ClO12)2 | [9.04 9.41 9.52] | 640.15 | 3.15 | 96.66 | 20.11 |
| B—Cl—Co—Li—O—Si | Li4CoSiB5ClO12 | [9.1 9.07 9.07] | 548.79 | 2.4 | 96.95 | 10.86 |
| B—Cl—Li—Mo—O—Y | Li8YB9Mo4(ClO12)2 | [9.25 8.69 9.33] | 598.81 | 3.0 | 97.1 | 8.1 |
| Al—B—Cl—La—Li—O | Li8La6AlB7(ClO12)2 | [9.83 9.62 9.67] | 718.05 | 3.35 | 97.21 | 1.82 |
| B—Cl—La—Li—Mo—O | Li4LaB5MoClO12 | [9.16 9.76 8.87] | 604.83 | 2.99 | 97.22 | 3.14 |
| B—Cl—Fe—Li—Mo—O | Li8FeB8Mo5(ClO12)2 | [9.1 8.95 9.23] | 595.47 | 3.16 | 97.28 | 5.83 |
| Al—As—Cl—La—Li—O | Li8LaAl3As10(ClO12)2 | [9.87 10.53 9.81] | 773.95 | 3.17 | 97.42 | −2.15 |
| Al—As—Cl—Li—O—Y | Li4YAl2As4ClO12 | [9.26 10.2 9.26] | 722.91 | 3.21 | 97.57 | 4.02 |
| B—Cl—Fe—Li—O—Y | Li8Y4Fe3B7(ClO12)2 | [9.39 9.38 8.93] | 618.23 | 2.98 | 97.63 | 11.5 |
| Al—As—B—Cl—Li—O | Li8AlB4As9(ClO12)2 | [9.58 9.56 9.59] | 707.99 | 2.94 | 97.64 | −1.93 |
| B—Cl—Li—Mo—O—Y | Li8Y2B11Mo(ClO12)2 | [9.19 9.3 8.77] | 574.1 | 2.61 | 97.97 | 7.53 |
| Al—As—Cl—La—Li—O | Li8LaAl5As8(ClO12)2 | [9.68 10.05 9.57] | 737.95 | 3.11 | 98.05 | −2.11 |
| As—B—Cl—Fe—Li—O | Li8FeB10As3(ClO12)2 | [9.23 8.94 8.84] | 567.21 | 2.63 | 98.16 | −0.95 |
| Al—B—Cl—La—Li—O | Li8La3AlB10(ClO12)2 | [9.22 9.88 9.39] | 626.99 | 2.81 | 98.23 | 0.82 |
| As—B—Cl—La—Li—O | Li8La3B3As8(ClO12)2 | [9.75 9.95 9.14] | 720.59 | 3.59 | 98.43 | −0.56 |
| Al—B—Cl—La—Li—O | Li4LaAl3B3ClO12 | [9.4 9.17 9.41] | 660.81 | 2.55 | 98.45 | −0.4 |
| As—Be—Cl—Li—O—Si | Li8BeSiAs12(ClO12)2 | [10.3 9.84 9.93] | 821.19 | 2.93 | 98.79 | 80.65 |
| Al—B—Cl—Li—O—Y | Li8Y3Al5B6(ClO12)2 | [9.18 9.25 9.21] | 653.16 | 2.48 | 99.16 | 8.55 |
| As—B—Cl—Li—Mo—O | Li4B5MoAsClO12 | [8.99 9.29 9.11] | 570.92 | 2.79 | 99.32 | 2.09 |
| B—Cl—Cr—Li—Mo—O | Li4CrB4Mo2ClO12 | [9.05 8.97 8.97] | 578.49 | 3.11 | 99.35 | 5.75 |
| B—Cl—Li—Mo—O—Y | Li8YB10Mo3(ClO12)2 | [8.92 9.63 8.77] | 590.78 | 2.8 | 99.39 | 6.86 |
| As—B—Cl—La—Li—O | Li8LaB11As2(ClO12)2 | [8.69 9.72 8.98] | 559.91 | 2.72 | 99.56 | −0.06 |
| Al—B—Cl—La—Li—O | Li8La3Al2B9(ClO12)2 | [9.55 9.46 9.46] | 633.64 | 2.83 | 99.68 | 0.64 |
| B—Cl—Li—Mo—O—Y | Li8Y5B7Mo2(ClO12)2 | [9.28 9.06 9.05] | 616.85 | 3.29 | 99.71 | 18.21 |
| B—Cl—Fe—Li—Mo—O | Li8FeB11Mo2(ClO12)2 | [8.8 9.14 9.09] | 548.54 | 2.66 | 99.95 | 2.11 |
| As—B—Cl—Fe—Li—O | Li8Fe5B4As5(ClO12)2 | [9.84 9.5 9.39] | 668.91 | 3.0 | 100.0 | −2.78 |
| B—Cl—Cr—La—Li—O | Li8La6CrB7(ClO12)2 | [9.39 9.92 10.08] | 705.18 | 3.47 | 100.01 | 2.4 |
| Al—B—Cl—Li—Mo—O | Li8AlB8Mo5(ClO12)2 | [9.19 9.05 8.81] | 594.65 | 3.08 | 100.04 | 6.01 |
| As—B—Cl—Fe—Li—O | Li4FeB4As2ClO12 | [9. 9.42 9.42] | 632.71 | 2.65 | 100.26 | −1.5 |
| Al—B—Cl—Li—O—Y | Li8Y6AlB7(ClO12)2 | [9.53 9.32 9.37] | 659.36 | 2.89 | 100.28 | 18.7 |
| As—B—Cl—Fe—Li—O | Li8Fe4B7As3(ClO12)2 | [9.34 9.41 9.26] | 629.95 | 2.73 | 100.29 | −2.03 |
| Al—B—Cl—Li—Mo—O | Li8Al3B7Mo4(ClO12)2 | [9.42 8.81 9.65] | 608.27 | 2.87 | 100.32 | 4.42 |
| B—Cl—La—Li—Mo—O | Li8La4B7Mo3(ClO12)2 | [9.36 9.32 9.33] | 660.38 | 3.59 | 100.52 | 5.05 |
| Al—B—Cl—Cr—Li—O | Li4AlCr2B4ClO12 | [9.32 8.52 9.32] | 568.01 | 2.51 | 100.59 | 1.24 |
| As—B—Cl—Li—O—Y | Li8YB10As3(ClO12)2 | [8.71 9.14 8.78] | 560.27 | 2.76 | 100.65 | 2.56 |
| As—B—Cl—Cr—Li—O | Li8Cr3B9As2(ClO12)2 | [9. 8.92 9.46] | 585.6 | 2.59 | 100.66 | 0.8 |
| B—Cl—Cr—Li—O—Y | Li8YCr3B10(ClO12)2 | [8.8 9.49 8.73] | 560.56 | 2.56 | 100.74 | 4.34 |
| Al—B—Cl—Cr—Li—O | Li8Al4Cr3B7(ClO12)2 | [9.38 9.03 9.3] | 586.44 | 2.41 | 100.86 | 0.48 |
| As—B—Cl—Li—O—Y | Li4YB2As4ClO12 | [9.16 9.65 9.16] | 662.1 | 3.34 | 100.93 | 4.73 |
| B—Cl—Cr—La—Li—O | Li8LaCr2B11(ClO12)2 | [8.92 9.4 8.97] | 558.19 | 2.59 | 101.0 | 1.13 |
| Al—As—B—Cl—Li—O | Li4AlB5AsClO12 | [9.09 9.42 9.45] | 554.03 | 2.46 | 101.01 | −0.75 |
| As—B—Cl—Fe—Li—O | Li8FeB4As9(ClO12)2 | [9.9 9.49 9.07] | 704.45 | 3.03 | 101.01 | −2.12 |
| Al—B—Cl—Cr—Li—O | Li8AlCr4B9(ClO12)2 | [9.21 8.46 9.27] | 551.22 | 2.54 | 101.02 | 1.41 |
| As—B—Cl—Li—O—Y | Li8Y3B3As8(ClO12)2 | [9.66 9.83 8.93] | 687.77 | 3.4 | 101.21 | 7.88 |
| As—Cl—Co—Li—O—Si | Li8CoSiAs12(ClO12)2 | [10.15 10.05 10.04] | 836.06 | 2.97 | 101.51 | 3.09 |
| As—B—Cl—Cr—Li—O | Li8CrB4As9(ClO12)2 | [10.03 9.24 9.51] | 702.36 | 3.03 | 101.7 | −1.36 |
| B—Cl—Fe—La—Li—O | Li8La2Fe5B7(ClO12)2 | [9.58 9.99 9.4] | 649.39 | 2.92 | 101.84 | −1.14 |
| Al—As—B—Cl—Li—O | Li8AlB7As6(ClO12)2 | [9.2 9.28 9.18] | 659.98 | 2.67 | 101.98 | −1.35 |
| B—Cl—La—Li—Mo—O | Li8La2B9Mo3(ClO12)2 | [9.11 9.6 8.99] | 626.51 | 3.11 | 102.19 | 4.38 |
| Al—B—Cl—Li—O—P | Li8Al7B6P(ClO12)2 | [9.22 9.22 9.63] | 613.28 | 2.15 | 102.24 | 28.52 |
| As—B—Cl—Fe—Li—O | Li8Fe3B4As7(ClO12)2 | [9.78 9.33 9.46] | 693.62 | 2.98 | 102.51 | −2.45 |
| B—Cl—Cr—La—Li—O | Li4LaCrB5ClO12 | [9.1 9.54 8.76] | 595.18 | 2.79 | 102.56 | 1.46 |
| B—Cl—Fe—La—Li—O | Li4La3FeB3ClO12 | [9.09 9.45 10.89] | 715.42 | 3.53 | 102.7 | 1.28 |
| B—Cl—Cr—Li—Mo—O | Li8Cr3B10Mo(ClO12)2 | [9.27 9.27 8.48] | 543.01 | 2.66 | 102.76 | 2.43 |
| B—Cl—Cr—Li—O—Y | Li8Y3CrB10(ClO12)2 | [9.04 8.91 9.14] | 585.92 | 2.66 | 102.95 | 9.84 |
| As—B—Cl—Li—Mo—O | Li8B9Mo3As2(ClO12)2 | [8.74 9.34 9.42] | 599.78 | 2.89 | 103.2 | 3.32 |
| As—B—Cl—Cr—Li—O | Li4CrB5AsClO12 | [8.85 9.18 9.] | 553.69 | 2.62 | 103.22 | 0.41 |
| B—Cl—Fe—Li—O—Y | Li8Y3Fe4B7(ClO12)2 | [9.05 9.58 9.39] | 623.71 | 2.87 | 103.29 | 7.99 |
| B—Cl—Cr—Li—Mo—O | Li4CrB5MoClO12 | [9.33 9.33 8.64] | 544.62 | 2.79 | 103.33 | 3.27 |
| B—Cl—Cr—La—Li—O | Li8LaCr3B10(ClO12)2 | [8.88 9.5 8.93] | 568.12 | 2.67 | 103.77 | 1.53 |
| B—Cl—Cr—Li—Mo—O | Li8Cr2B11Mo(ClO12)2 | [8.59 9.08 9.07] | 539.95 | 2.55 | 103.78 | 2.03 |
| B—Cl—La—Li—O—Y | Li8LaY3B10(ClO12)2 | [9.11 9.33 9.51] | 617.79 | 2.75 | 103.89 | 9.77 |
| As—B—Cl—Li—O—Y | Li8YB5As8(ClO12)2 | [9.63 9.51 9.93] | 633.73 | 3.28 | 103.89 | 1.59 |
| Al—B—Cl—Li—Mo—O | Li8Al5B6Mo3(ClO12)2 | [9.91 8.76 9.71] | 615.01 | 2.69 | 104.03 | 2.82 |
| As—B—Cl—Fe—Li—O | Li8Fe3B2As9(ClO12)2 | [10.24 9.25 9.31] | 720.31 | 3.17 | 104.37 | −2.84 |
| B—Cl—Cr—La—Li—O | Li8LaCr4B9(ClO12)2 | [9.05 9.43 9.11] | 567.1 | 2.8 | 104.43 | 1.92 |
| B—Cl—Li—O—Si—V | Li8V3Si3B8(ClO12)2 | [9.43 9.25 9.22] | 598.06 | 2.32 | 104.68 | 5.17 |
| Al—As—B—Cl—Li—O | Li8AlB10As3(ClO12)2 | [8.78 9.33 8.93] | 568.76 | 2.54 | 104.74 | −0.76 |
| As—B—Cl—Li—O—Y | Li8Y2B11As(ClO12)2 | [8.89 10.04 9.73] | 548.15 | 2.67 | 104.8 | 6.1 |
| As—B—Cl—Li—O—Y | Li4Y2BAs4ClO12 | [10.01 8.85 10.01] | 742.79 | 3.32 | 105.36 | 11.03 |
| As—B—Cl—Li—O—Y | Li8YB2As11(ClO12)2 | [11.27 10.69 8.93] | 763.48 | 3.14 | 105.49 | 1.0 |
| As—B—Cl—Fe—Li—O | Li8FeB3As10(ClO12)2 | [10.04 9.48 9.57] | 766.35 | 2.92 | 105.56 | −2.31 |
| As—B—Cl—Cr—Li—O | Li8CrB8As5(ClO12)2 | [8.98 9.16 9.4] | 630.07 | 2.7 | 105.61 | −0.58 |
| As—B—Cl—Cr—Li—O | Li4CrB2As4ClO12 | [9.92 9.37 9.37] | 707.54 | 2.95 | 105.81 | −0.76 |
| B—Cl—Cr—Li—O—Y | Li8Y5Cr2B7(ClO12)2 | [9.31 9.03 8.94] | 601.57 | 3.13 | 106.24 | 16.53 |
| As—B—Cl—Fe—Li—O | Li8Fe3BAs10(ClO12)2 | [10.41 9.8 9.83] | 764.75 | 3.12 | 106.29 | −3.03 |
| As—B—Cl—Li—Mo—O | Li8B10Mo3As(ClO12)2 | [8.78 9.18 9.24] | 565.99 | 2.88 | 106.32 | 3.52 |
| B—Cl—Cr—Li—O—Y | Li8Y6CrB7(ClO12)2 | [9.09 9.56 9.64] | 637.77 | 3.05 | 106.71 | 19.28 |
| As—B—Cl—La—Li—O | Li8LaB8As5(ClO12)2 | [9.07 10.19 10.78] | 645.86 | 2.85 | 107.09 | −0.64 |
| Al—B—Cl—Fe—Li—O | Li8Al5Fe4B5(ClO12)2 | [9.61 9.86 9.69] | 639.73 | 2.4 | 107.29 | −2.34 |
| As—B—Cl—Fe—Li—O | Li8FeB8As5(ClO12)2 | [9.06 9.17 9.49] | 641.56 | 2.66 | 107.3 | −1.34 |
| Al—B—Cl—Li—O—Y | Li8Y5Al2B7(ClO12)2 | [9.37 9.48 9.16] | 656.81 | 2.74 | 107.5 | 15.38 |
| As—B—Cl—La—Li—O | Li8La2B11As(ClO12)2 | [8.87 10.18 9.99] | 564.99 | 2.89 | 107.68 | 0.47 |
| As—B—Cl—Li—O—Y | Li8YB8As5(ClO12)2 | [9.08 10.26 10.44] | 634.29 | 2.78 | 107.81 | 2.17 |
| B—Cl—Fe—Li—O—Y | Li4YFe3B3ClO12 | [9.4 10.05 10.05] | 675.62 | 2.67 | 107.95 | 4.12 |
| As—B—Cl—Li—O—Y | Li8Y5BAs8(ClO12)2 | [9.73 8.82 10.53] | 731.53 | 3.55 | 108.08 | 14.17 |
| As—B—Cl—Fe—Li—O | Li4FeB3As3ClO12 | [9.26 9.12 9.56] | 655.87 | 2.88 | 108.13 | −1.89 |
| As—B—Cl—Fe—Li—O | Li8FeB7As6(ClO12)2 | [9.62 9.08 9.09] | 666.48 | 2.72 | 108.21 | −1.53 |
| Al—B—Cl—Li—Mo—O | Li8AlB7Mo6(ClO12)2 | [8.78 9.09 9.16] | 600.83 | 3.29 | 108.21 | 7.25 |
| Al—As—B—Cl—Li—O | Li8Al2BAs11(ClO12)2 | [9.77 9.79 10.12] | 759.69 | 3.06 | 108.51 | −2.5 |
| B—Cl—La—Li—O—Y | Li8La3YB10(ClO12)2 | [9.18 9.79 9.46] | 646.12 | 2.89 | 108.63 | 4.15 |
| Al—B—Cl—Li—O—Y | Li8YAl8B5(ClO12)2 | [9.54 9.4 9.17] | 639.47 | 2.26 | 109.01 | 1.72 |
| B—Cl—Fe—La—Li—O | Li4LaFe3B3ClO12 | [9.48 10.24 10.24] | 700.33 | 2.82 | 109.28 | −1.5 |
| Al—As—Cl—La—Li—O | Li4LaAl2As4ClO12 | [9.43 10.23 9.43] | 748.33 | 3.32 | 109.38 | −1.6 |
| B—Cl—Cr—Li—O—Y | Li8Y2Cr3B9(ClO12)2 | [8.87 9.43 8.75] | 579.74 | 2.7 | 109.6 | 7.49 |
| Al—As—B—Cl—Li—O | Li8Al8B5As(ClO12)2 | [9.55 9.15 9.32] | 632.36 | 2.25 | 109.87 | −1.62 |
| Al—B—Cl—Li—O—Y | Li8Y4Al3B7(ClO12)2 | [9.42 9.33 9.34] | 657.39 | 2.58 | 109.89 | 12.05 |

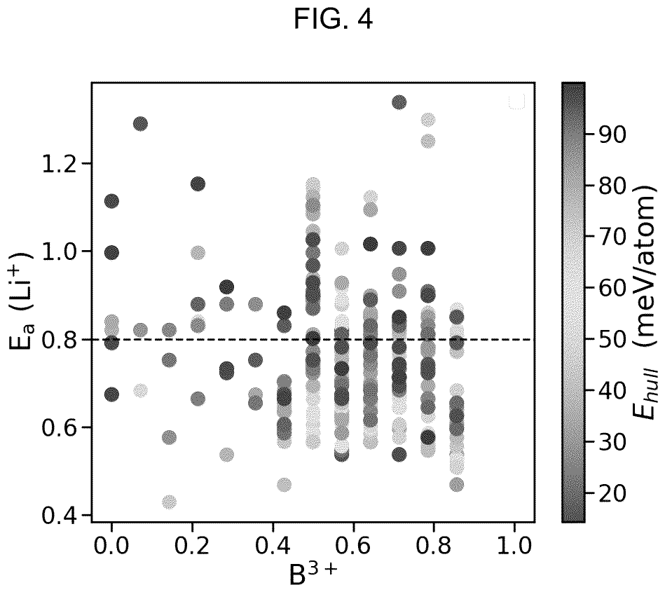

FIG. 4 shows an exemplary embodiment with (A) Eₕᵤₗₗ<100 meV/atom and (B) high Li conductivity. In particular, FIG. 4 shows the optimization of low-Eₕᵤₗₗ multi-component Li₄₋ₓB_{7-y}M_{y}O_{12-z}Cl_{w} where the compositions' content is tailored to increase the Li-ion conductivity.

Assume the following dummy species:
A with oxidation state of 0+
D with oxidation state 3+/−
X with oxidation state 2+
E with oxidation state 4+
G with oxidation state 5+
Z with oxidation state 6+

### Disclosed Chemical Spaces:

Li—Cl—O-D|Cl—Li—O—X-D-E|Cl—Li—O-D-G-X|Cl—Li—O-A-D-Z

The following stoichiometry ranges are disclosed:
D from 0 to 0.86:
   Al³⁺→[0, 0.5]
   Fe³⁺→[0, 0.43]
   La³⁺→[0, 0.29]
   Y³⁺→[0, 0.36]
   B³⁺→[0, 0.86]
   Mo³⁺→[0, 0.36]
   Cr³⁺→[0, 0.21]
   As³⁺→[0, 0.65]
X from 0 to 0.43:
   Be²⁺→[0, 0.43]
   Mn²⁺→[0, 0.22]
   V²⁺/Co²⁺/Fe²⁺→[0, 0.14]
   Ge²⁺/Ti²⁺→[0, 0.07]
E from 0 to 0.43:
   Si⁴⁺→[0, 0.43]
   Mo⁴⁺→[0, 0.14]
Z from 0 to 0.14
   Mo⁶⁺→[0, 0.14]
G from 0 to 0.14:
   P⁵⁺→[0, 0.14]
A from 0 to 0.14
   As⁰⁺→[0, 0.14]

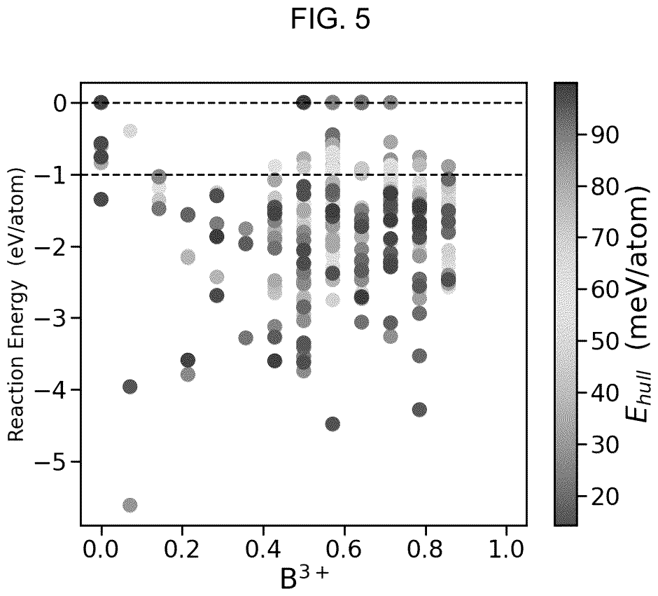

FIG. 5 shows an exemplary embodiment with (A) Eₕᵤₗₗ<100 meV/atom, (B) high Li conductivity, and (C) high moisture stability. In particular, FIG. 5 shows the optimization of low-Eₕᵤₗₗ multi-component Li₄₋ₓB_{7-y}M_{y}O_{12-z}Cl_{w} where the compositions' content is tailored to increase the compositions' stability against water.

Assume the following dummy species:
A with oxidation state of 1+
D with oxidation state 3+/−
X with oxidation state 2+
E with oxidation state 4+
G with oxidation state 5+
Z with oxidation state 6+

### Disclosed Chemical Spaces:

Cl—Li—O-D|Cl—Li—O-D-E-X

The following stoichiometry ranges are disclosed:
D from 0 to 0.86:
   Al³⁺→[0, 0.5]
   Fe³⁺→[0, 0.43]
   B³⁺→[0, 0.86]
   La³⁺→[0, 0.28]
   Y³⁺→[0, 0.36]
   Mo³⁺→[0, 0.28]
   Cr³⁺→[0, 0.14]
   As³⁺→[0, 0.57]
X from 0 to 0.43:
   Mn²⁺→[0, 0.15]
E from 0 to 0.43:
   Si⁴⁺→[0, 0.14]

Table 2 shows a list of example compositions of the exemplary embodiment with (A) Eₕᵤₗₗ<100 me V/atom, (B) high Li conductivity, and (C) high moisture stability.

TABLE 2
List of example compositions with (A) Eₕᵤₗₗ < 100 meV/atom,
(B) high Li conductivity, and (C) high moisture stability

| | Eₕᵤₗₗ | Eₐ(Li) | R × N Water | |
|---|---|---|---|---|
| Formula | (meV/atom) | (eV) | (eV/atom) | Elements |
| Li8Al5FeB8(ClO12)2 | 14.25 | 0.54 | −0.54 | [‘Li+’, ‘Al3+’, ‘Fe3+’, ‘B3+’, ‘Cl−’, ‘O2−’] |
| Li4Al2FeB4ClO12 | 20.73 | 0.55 | −0.46 | [‘Li+’, ‘Al3+’, ‘Fe3+’, ‘B3+’, ‘Cl−’, ‘O2−’] |
| Li4LaY2B4ClO12 | 25.16 | 0.76 | 0.0 | [‘Li+’, ‘La3+’, ‘Y3+’, ‘B3+’, ‘Cl−’, ‘O2−’] |
| Li8Al4FeB9(ClO12)2 | 25.38 | 0.57 | −0.92 | [‘Li+’, ‘Al3+’, ‘Fe3+’, ‘B3+’, ‘Cl−’, ‘O2−’] |
| Li8LaY5B8(ClO12)2 | 27.06 | 0.77 | 0.0 | [‘Li+’, ‘La3+’, ‘Y3+’, ‘B3+’, ‘Cl−’, ‘O2−’] |
| Li8Al3Fe3B8(ClO12)2 | 28.15 | 0.56 | −0.88 | [‘Li+’, ‘Al3+’, ‘Fe3+’, ‘B3+’, ‘Cl−’, ‘O2−’] |
| Li8Al3FeB10(ClO12)2 | 28.98 | 0.64 | −0.8 | [‘Li+’, ‘Al3+’, ‘Fe3+’, ‘B3+’, ‘Cl−’, ‘O2−’] |
| Li4Al2B4MoClO12 | 30.82 | 0.62 | −0.67 | [‘Li+’, ‘Al3+’, ‘B3+’, ‘Mo3+’, ‘Cl−’, ‘O2−’] |
| Li8Al2FeB11(ClO12)2 | 31.63 | 0.57 | −0.76 | [‘Li+’, ‘Al3+’, ‘Fe3+’, ‘B3+’, ‘Cl−’, ‘O2−’] |
| Li8AlFeB12(ClO12)2 | 31.97 | 0.47 | −0.89 | [‘Li+’, ‘Al3+’, ‘Fe3+’, ‘B3+’, ‘Cl−’, ‘O2−’] |
| Li8Al3Fe2B9(ClO12)2 | 32.92 | 0.57 | −0.96 | [‘Li+’, ‘Al3+’, ‘Fe3+’, ‘B3+’, ‘Cl−’, ‘O2−’] |
| Li4AlFeB5ClO12 | 33.97 | 0.6 | −0.55 | [‘Li+’, ‘Al3+’, ‘Fe3+’, ‘B3+’, ‘Cl−’, ‘O2−’] |
| Li4AlFe2B4ClO12 | 34.05 | 0.56 | −0.59 | [‘Li+’, ‘Al3+’, ‘Fe3+’, ‘B3+’, ‘Cl−’, ‘O2−’] |
| Li8Al6FeB7(ClO12)2 | 35.9 | 0.57 | −0.78 | [‘Li+’, ‘Al3+’, ‘Fe3+’, ‘B3+’, ‘Cl−’, ‘O2−’] |
| Li8AlFe2B11(ClO12)2 | 39.19 | 0.58 | −0.87 | [‘Li+’, ‘Al3+’, ‘Fe3+’, ‘B3+’, ‘Cl−’, ‘O2−’] |
| Li8AlFe5B8(ClO12)2 | 40.17 | 0.59 | −0.89 | [‘Li+’, ‘Al3+’, ‘Fe3+’, ‘B3+’, ‘Cl−’, ‘O2−’] |
| Li8Al2Fe3B9(ClO12)2 | 40.94 | 0.57 | −0.99 | [‘Li+’, ‘Al3+’, ‘Fe3+’, ‘B3+’, ‘Cl−’, ‘O2−’] |
| Li8AlFe4B9(ClO12)2 | 43.99 | 0.59 | −0.92 | [‘Li+’, ‘Al3+’, ‘Fe3+’, ‘B3+’, ‘Cl−’, ‘O2−’] |
| Li8Al6B7Mo(ClO12)2 | 44.47 | 0.72 | −0.9 | [‘Li+’, ‘Al3+’, ‘B3+’, ‘Mo3+’, ‘Cl−’, ‘O2−’] |
| Li8Y5B8Mo(ClO12)2 | 44.62 | 0.78 | 0.0 | [‘Li+’, ‘Y3+’, ‘B3+’, ‘Mo3+’, ‘Cl−’, ‘O2−’] |
| Li8AlFe3B10(ClO12)2 | 45.18 | 0.61 | −0.9 | [‘Li+’, ‘Al3+’, ‘Fe3+’, ‘B3+’, ‘Cl−’, ‘O2−’] |
| Li8Al5BAs8(ClO12)2 | 50.7 | 0.68 | −0.39 | [‘Li+’, ‘Al3+’, ‘B3+’, ‘As3+’, ‘Cl−’, ‘O2−’] |
| Li4YA2B4ClO12 | 51.9 | 0.65 | −0.96 | [‘Li+’, ‘Y3+’, ‘Al3+’, ‘B3+’, ‘Cl−’, ‘O2−’] |
| Li4Y2FeB4ClO12 | 56.0 | 0.79 | −0.92 | [‘Li+’, ‘Y3+’, ‘Fe3+’, ‘B3+’, ‘Cl−’, ‘O2−’] |
| Li8Y5AlB8(ClO12)2 | 56.16 | 0.77 | 0.0 | [‘Li+’, ‘Y3+’, ‘Al3+’, ‘B3+’, ‘Cl−’, ‘O2−’] |
| Li4Al3FeB3ClO12 | 56.33 | 0.58 | −0.88 | [‘Li+’, ‘Al3+’, ‘Fe3+’, ‘B3+’, ‘Cl−’, ‘O2−’] |
| Li4Al2CrB4ClO12 | 56.82 | 0.56 | −0.96 | [‘Li+’, ‘Al3+’, ‘Cr3+’, ‘B3+’, ‘Cl−’, ‘O2−’] |
| Li4YFe2B4ClO12 | 57.74 | 0.72 | −0.7 | [‘Li+’, ‘Y3+’, ‘Fe3+’, ‘B3+’, ‘Cl−’, ‘O2−’] |
| Li4Y2B4MoClO12 | 58.78 | 0.78 | 0.0 | [‘Li+’, ‘Y3+’, ‘B3+’, ‘Mo3+’, ‘Cl−’, ‘O2−’] |
| Li8Y3B8Mo3(ClO12)2 | 60.42 | 0.69 | 0.0 | [‘Li+’, ‘Y3+’, ‘B3+’, ‘Mo3+’, ‘Cl−’, ‘O2−’] |
| Li8La3B8Mo3(ClO12)2 | 61.43 | 0.77 | 0.0 | [‘Li+’, ‘La3+’, ‘B3+’, ‘Mo3+’, ‘Cl−’, ‘O2−’] |
| Li4MnSiB5ClO12 | 63.97 | 0.67 | −0.95 | [‘Li+’, ‘Mn2+’, ‘Si4+’, ‘B3+’, ‘Cl−’, ‘O2−’] |
| Li8Y5CrB8(ClO12)2 | 69.13 | 0.76 | 0.0 | [‘Li+’, ‘Y3+’, ‘Cr3+’, ‘B3+’, ‘Cl−’, ‘O2−’] |
| Li4YB4Mo2ClO12 | 70.83 | 0.71 | 0.0 | [‘Li+’, ‘Y3+’, ‘B3+’, ‘Mo3+’, ‘Cl−’, ‘O2−’] |
| Li4LaB4Mo2ClO12 | 77.09 | 0.77 | 0.0 | [‘Li+’, ‘La3+’, ‘B3+’, ‘Mo3+’, ‘Cl−’, ‘O2−’] |
| Li8Y4B9Mo(ClO12)2 | 77.29 | 0.66 | 0.0 | [‘Li+’, ‘Y3+’, ‘B3+’, ‘Mo3+’, ‘Cl−’, ‘O2−’] |
| Li8La4B9Mo(ClO12)2 | 82.94 | 0.72 | 0.0 | [‘Li+’, ‘La3+’, ‘B3+’, ‘Mo3+’, ‘Cl−’, ‘O2−’] |
| Li8La3B9Mo2(ClO12)2 | 83.0 | 0.77 | 0.0 | [‘Li+’, ‘La3+’, ‘B3+’, ‘Mo3+’, ‘Cl−’, ‘O2−’] |
| Li8Y3B9Mo2(ClO12)2 | 85.4 | 0.79 | 0.0 | [‘Li+’, ‘Y3+’, ‘B3+’, ‘Mo3+’, ‘Cl−’, ‘O2−’] |
| Li4Y2CrB4ClO12 | 88.74 | 0.7 | 0.0 | [‘Li+’, ‘Y3+’, ‘Cr3+’, ‘B3+’, ‘Cl−’, ‘O2−’] |
| Li8La4CrB9(ClO12)2 | 91.4 | 0.76 | 0.0 | [‘Li+’, ‘La3+’, ‘Cr3+’, ‘B3+’, ‘Cl−’, ‘O2−’] |
| Li8Y4CrB9(ClO12)2 | 91.87 | 0.68 | 0.0 | [‘Li+’, ‘Y3+’, ‘Cr3+’, ‘B3+’, ‘Cl−’, ‘O2−’] |
| Li4YAl2As4ClO12 | 97.57 | 0.79 | −0.57 | [‘Li+’, ‘Y3+’, ‘Al3+’, ‘As3+’, ‘Cl−’, ‘O2−’] |
| Li8LaAl5As8(ClO12)2 | 98.05 | 0.67 | −0.76 | [‘Li+’, ‘La3+’, ‘Al3+’, ‘As3+’, ‘Cl−’, ‘O2−’] |

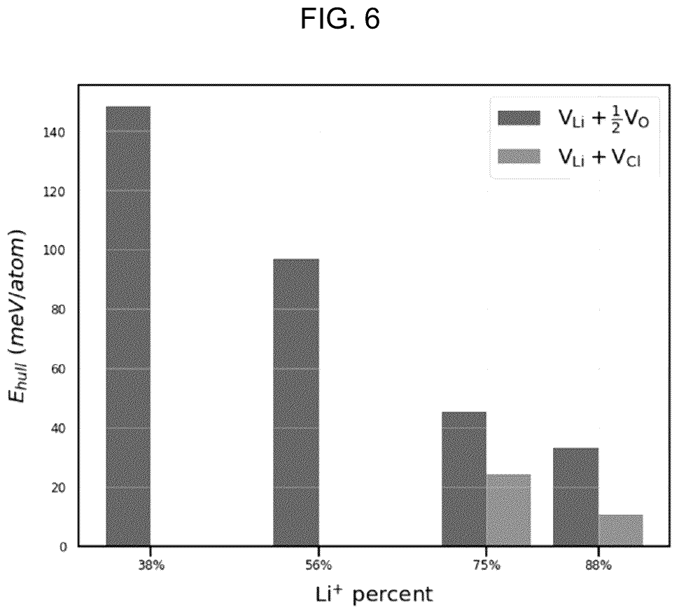

FIG. 6 is a graph showing defects dopant strategies in an exemplary embodiment. Based on the results shown in FIG. 6, it is proven that one can introduce Li⁺ vacancies balanced by Cl⁻ vacancies, as well as some minor 1/2O²⁻ vacancies.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A compound of the formula Li₄₋ₓB_{7-y}M_{y}O_{12-z}Cl_{w}, wherein Li, O, and Cl vacancies are allowed and M is either a one-way, two-way or three-way combination of the following species: Al³⁺, Fe³⁺, B³⁺, La³⁺, Y³⁺, Mo³⁺, Be²⁺, Si⁴⁺, Cr⁴⁺, As³⁺, Mn²⁺, V²⁺, Co²⁺, Ge²⁺, Fe²⁺, Mo⁴⁺, Mo⁶⁺, As³⁻, Ti²⁺, P⁵⁺, As⁰⁺, and wherein 0≤x<2, 0<y<6, 0≤z<1, and 0<w<2 either satisfy a charge balance mechanism with their respective defect site B³⁺, Li⁺, O²⁻, or Cl⁻, or satisfy any combination that maintains charge neutrality of the compound, and wherein when M comprises Al³⁺, M is a two-way or three-way combination.

2. The compound according to claim 1, wherein 0<x<2, 0<y<6, 0<z<1, and 0<w<2.

3. The compound according to claim 1, wherein the compound is Li₈Y₄B₉Mo(ClO₁₂)₂.

4. The compound according to claim 1, wherein the compound is Li₈Y₄CrB₉(ClO₁₂)₂.

5. The compound according to claim 1, wherein the compound is Li₈Y₃B₈Mo₃(ClO₁₂)₂.

6. The compound according to claim 1, wherein M is one, two, or three of Fe³⁺, La³⁺, Y³⁺, Mo³⁺, Cr⁴⁺, As³⁺, Fe²⁺, Mo⁴⁺, Mo⁶⁺, As³⁻, or As⁰⁺ or two or three of Al³⁺, Fe³⁺, La³⁺, Y³⁺, Mo³⁺, Cr⁴⁺, As³⁺, Fe²⁺, Mo⁴⁺, Mo⁶⁺, As³⁻, or As⁰⁺.

7. The compound according to claim 1, wherein M is a two-way combination.

8. The compound according to claim 6, wherein M is a two-way combination.

9. A glass ceramic composition comprising the compound according to claim 1.

10. A glass ceramic composition comprising the compound according to claim 2.

11. A glass ceramic composition comprising the compound according to claim 7.

12. A glass ceramic composition comprising the compound according to claim 8.

13. A lithium ion battery comprising a solid state ionic conductor, wherein the solid state ionic conductor comprises the compound according to claim 1.

14. A lithium ion battery comprising a solid state ionic conductor, wherein the solid state ionic conductor comprises the compound according to claim 2.

15. A lithium ion battery comprising a solid state ionic conductor, wherein the solid state ionic conductor comprises the compound according to claim 3.

16. A lithium ion battery comprising a solid state ionic conductor, wherein the solid state ionic conductor comprises the compound according to claim 4.

17. A lithium ion battery comprising a solid state ionic conductor, wherein the solid state ionic conductor comprises the compound according to claim 5.

18. A lithium ion battery comprising a solid state ionic conductor, wherein the solid state ionic conductor comprises the compound according to claim 6.

19. A lithium ion battery comprising a solid state ionic conductor, wherein the solid state ionic conductor comprises the compound according to claim 7.

20. A lithium ion battery comprising a solid state ionic conductor, wherein the solid state ionic conductor comprises the compound according to claim 8.
